(19) United States
(12) Patent Application Publication
(10) Pub. No.: US 2006/0095367 A1
(43) Pub. Date: May 4, 2006

(54) System and method of supply chain procurement, settlement and finance

(76) Inventor: Jorn Iverson, Toronto (CA)

Correspondence Address: PEARNE & GORDON LLP, 1801 EAST 9TH STREET, SUITE 1200, CLEVELAND, OH, 44114-3108, US

(21) Appl. No.: 11/234,728

(22) Filed: Sep. 23, 2005

Related U.S. Application Data
(60) Provisional application No. 60/711,245, filed on Aug. 25, 2005.

(30) Foreign Application Priority Data
Sep. 23, 2004 (CA) 2,482,506

(51) Int. Cl. G06Q 40/00

(52) U.S. Cl. 705/39

(57) ABSTRACT

A supply chain procurement, settlement and finance system and method of providing procurement and settlement logistics for buyers and financing for suppliers is provided. The system comprises a transaction module for purchasing and receiving goods and services from a supplier, a finance module for providing a financial interest for the goods and services, a settlement module for determining and settling supplier and non-supplier obligations, and a repository for storing buyer data and administration data of the transaction module, finance module and settlement module. The method comprises the steps of issuing to a supplier a purchase order for goods and services, providing a financial interest to the goods and services, computing the amount owing to a supplier when an invoice is not used as the primary document to determine a liability to a supplier, processing invoices and tabulating liabilities owing to suppliers, paying the supplier, selling and collecting proceeds from the sale of goods and services sold to customers and consumers of buyer, and retiring the financial interest to the goods and services.

This application claims the benefit of U.S. Provisional Patent Application Ser. No. 60/711,245 filed Aug. 25, 2005, the contents of which are incorporated herein by reference in their entirety.

### FIELD OF INVENTION

The invention relates generally to e-commerce, and in particular to a system and method of supply chain procurement, settlement and finance.

### BACKGROUND OF THE INVENTION

In a typical trading relationship, a Buyer will purchase goods and services from its suppliers, take delivery, offer no security interest to the suppliers, provide security interests in such goods and services to other creditors, sell the Goods and then discharge its obligations to its suppliers. In most cases, suppliers are paid 55-60 days following Trade Day.

FIG. 1 outlines an example of a financing structure and process in a typical trading relationship 10, and particularly how a typical transaction is initiated, completed and financed. A buyer 12 issues a purchase order for goods and services (22) from a supplier 14. The supplier 14 ships the goods or provides the services (24) to the buyer 12. Next, the supplier 14 sends an invoice to the buyer 12 (26). A bank 16 provides financing for outstanding accounts receivable of the supplier 14 (28). Typically, the financing covers 70 to 80% of outstanding accounts receivable belonging to the supplier 14. The supplier 14 usually provides the remaining funding. Normally, within 30 to 90 days the buyer 12 pays the invoice (30). With the proceeds from the payment of the invoice, the supplier 14 is able to repay the bank 16 (32).

One problem with the financing in the typical trading relationship is costly. The costs to finance products moving through the supply chain is estimated to be over four percent (4%) of gross domestic product (GDP) in 1998 in the United States and approach the costs associated with transportation and distribution. When one considers the total dollar value of goods shipped through third party providers, the value created by reducing the financing cost by even a few basis points is far greater than any cost savings possible from traditional transportation and warehousing targets. The relentless pressure on suppliers in virtually every industry to accept longer and longer trade terms to enhance their customers' return on invested capital (ROIC) and return on assets (ROA) comes from Wall Street pressure: when managing ROA, if you cannot up the “R,” cut the “A”. In short, own the goods and services for the shortest time possible. Objective coordination with information exchange and physical movement through the supply chain to support the financing of goods and services as it passes from one participant to the next is rare. As a result, process duplication occurs between suppliers utilizing a variety of different finance providers.

There exists prior art that teaches a system and method of financing a supply chain by having a supplier provide a buyer an electronic invoice for goods. A financial institution then accesses the electronic invoice, stored on either the supplier's network or the reseller's network, and pays the supplier. Once the buyer sells the goods, the buyer settles with the financial institution. One problem with the prior art system is that it is intrusive since the financial institution is allowed to access a company's database. That is, the financial institution intrudes into the buyer's system or the supplier's system.

There is a need to reduce the cost of financing the relationships embedded in supply chains.

### SUMMARY OF THE INVENTION

The present invention describes a solution to the operation of inefficient supply chains by reducing the process, administrative and financing costs for all constituents. One embodiment of the present invention consolidates the physical and the financial supply chains into one seamless process that increases the economic value of trading relationships for the trading partners.

In accordance with an embodiment of the present invention, there is provided a supply chain procurement, settlement and finance system for providing supply chain procurement, settlement and finance. The system comprises a transaction module for purchasing and receiving goods and services from a supplier, a finance module for providing a financial interest for the goods and services, a settlement module for determining and settling supplier and non-supplier obligations, and a repository for storing buyer data and administration data of the transaction module, finance module and settlement module.

In accordance with another embodiment of the present invention, there is provided a method of supply chain procurement, settlement and finance. The method comprises the steps of issuing to a supplier a purchase order for goods and services, providing a financial interest to the goods and services, computing the amount owing to a supplier when an invoice is not used as the primary document to determine a liability to a supplier, processing invoices and tabulating liabilities owing to suppliers, paying the supplier, selling and collecting proceeds from the sale of goods and services sold to customers and consumers of buyer, and retiring the financial interest to the goods and services.

In accordance with another embodiment of the present invention, there is provided a computer data signal embodied in a carrier wave and representing sequences of instructions which, when executed by a processor, cause the processor to perform a method of supply chain finance in trading relationships. The method comprises the steps of issuing to a supplier a purchase order for goods and services, providing a financial interest in the goods and services for purchasers of asset backed commercial paper, paying the supplier, and retiring the financial interest in the goods and services by applying the proceeds resulting from the sale of goods and services to repay the asset backed commercial paper.

In accordance with another embodiment of the present invention, there is provided a computer data signal embodied in a carrier wave and representing sequences of instructions which, when executed by a processor, cause the processor to perform a method of supply chain procurement, settlement and finance. The method comprises the steps of issuing to a supplier a purchase order for goods and services, receiving settlement details from a buyer and a custodian, providing a financial interest to the goods and services, determining a liability owing to suppliers of goods and services, paying the supplier, communicating settlement and banking details to suppliers, and retiring the financial interest to the goods and services.

In accordance with another embodiment of the present invention, there is provided a carrier wave embodying a computer data signal representing sequences of instructions which, when executed by a processor, cause the processor to perform a method of supply chain procurement, settlement and finance. The method comprises the steps of issuing to a supplier a purchase order for goods and services, receiving settlement details from a buyer and a custodian, providing a financial interest to the goods and services, determining the liability owing to suppliers of goods and services, paying the supplier, communicating settlement and banking details to suppliers, and retiring the financial interest to the goods and services.

In accordance with another embodiment of the present invention, there is provided a computer program product for use in the execution in a computer of a supply chain procurement, settlement and finance system for providing supply chain procurement, settlement and finance. The computer program product comprises a transaction module for purchasing and receiving goods and services from a supplier, a finance module for providing a financial interest for the goods and services, a settlement module for determining and settling supplier and non-supplier obligations, and a repository for storing buyer data and administration data of the transaction module, finance module and settlement module.

### BRIEF DESCRIPTION OF THE DRAWINGS

These and other features of the invention will become more apparent from the following description in which reference is made to the appended drawings wherein:

FIG. 1 outlines an example of a financing structure and process in a typical trading relationship, and particularly how a typical transaction is initiated, completed and financed.

FIG. 2 shows in a block diagram an example of a supply chain procurement, settlement and finance system for providing procurement and settlement logistics for buyers and financing for suppliers, in accordance with an embodiment of the present invention.

FIG. 3 shows in a flowchart an example of a method of providing procurement and settlement logistics for buyers and financing for suppliers, in accordance with an embodiment of the supply chain procurement, settlement and finance system.

FIG. 4 shows in a process flow diagram an example of a method of a non-financing cash deal, in accordance with an embodiment of the supply chain procurement, settlement and finance system.

FIG. 5 shows in a process flow diagram an example of a method of a non-financing term deal, in accordance with an embodiment of the supply chain procurement, settlement and finance system.

FIG. 6 shows in a process flow diagram an example of a method of a financing deal, in accordance with an embodiment of the supply chain procurement, settlement and finance system.

FIG. 7 shows in a block diagram an example of a transaction module, in accordance with an embodiment of the supply chain procurement, settlement and finance system.

FIG. 8 shows in a block diagram an example of an invoice free transaction submodule, in accordance with an embodiment of the supply chain procurement, settlement and finance system.

FIG. 9 shows in a block diagram an example of an invoice based transaction submodule, in accordance with an embodiment of the supply chain procurement, settlement and finance system.

FIG. 10 shows in a block diagram an example of a finance module, in accordance with an embodiment of the supply chain procurement, settlement and finance system.

FIG. 11 shows in a block diagram an example of a financing deal with asset backed commercial paper finance submodule, in accordance with an embodiment of the supply chain procurement, settlement and finance system.

FIG. 12 shows in a block diagram an example of a selling and collection of goods and services financed by asset backed commercial paper finance submodule, in accordance with an embodiment of the supply chain procurement, settlement and finance system.

FIG. 13 shows in a block diagram an example of a financing deal with net cash finance submodule, in accordance with an embodiment of the supply chain procurement, settlement and finance system.

FIG. 14 shows in a block diagram an example of a financing deal with promissory note finance submodule, in accordance with an embodiment of the supply chain procurement, settlement and finance system.

FIG. 15 shows in a block diagram an example of a settlement module, in accordance with an embodiment of the supply chain procurement, settlement and finance system.

FIG. 16 shows in a block diagram an example of a liability referencing supplier discount matrix settlement submodule, in accordance with an embodiment of the supply chain procurement, settlement and finance system.

FIG. 17 shows in a block diagram an example of a depositary bank settlement submodule for direct deposits, in accordance with an embodiment of the supply chain procurement, settlement and finance system.

FIG. 18 shows in a block diagram an example of a communication of liabilities and settlement submodule, in accordance with an embodiment of the supply chain procurement, settlement and finance system.

FIG. 19 shows in a block diagram an example of a non-supplier obligations settlement submodule, in accordance with an embodiment of the supply chain procurement, settlement and finance system.

FIG. 20 shows in a block diagram an example of a repository module, in accordance with an embodiment of the supply chain procurement, settlement and finance system.

FIG. 21 shows in flowchart another example of a method of providing procurement and settlement logistics for buyers and financing for suppliers, in accordance with an embodiment of the supply chain procurement, settlement and finance system.

FIG. 22 shows in a component diagram an example of a network and technology platform, in accordance with an embodiment of the supply chain procurement, settlement and finance system.

FIG. 23 shows an example of a business process and communication platform technology architecture, in accordance with an embodiment of the supply chain procurement, settlement and finance system.

FIG. 24 shows examples of buyer subsystems, in accordance with an embodiment of the supply chain procurement, settlement and finance system.

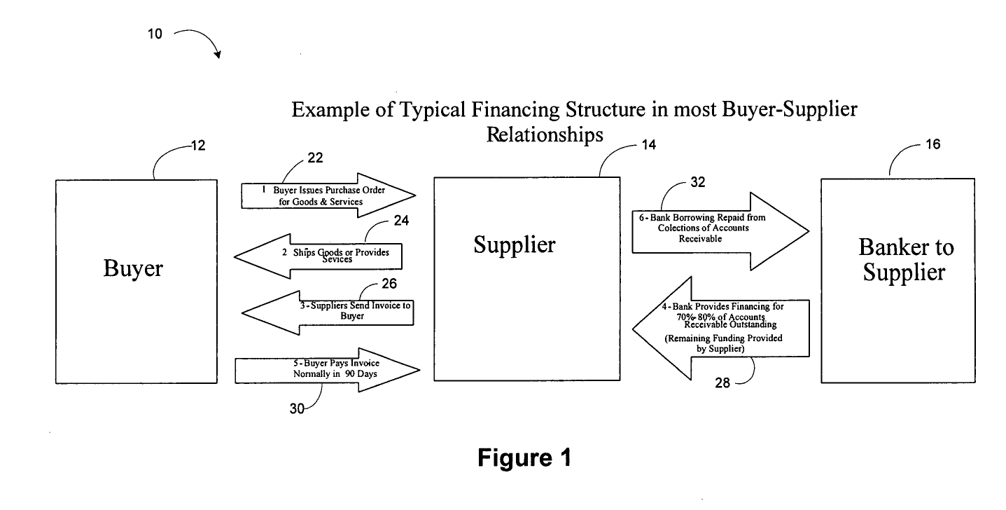

### DETAILED DESCRIPTION OF THE PREFERRED EMBODIMENTS

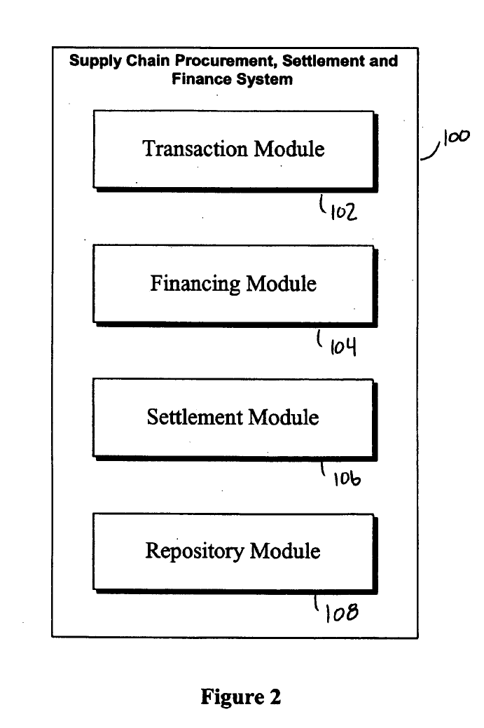

FIG. 2 shows in a block diagram an example of a supply chain procurement, settlement and finance system 100 for providing procurement and settlement logistics for buyers and financing for suppliers, in accordance with an embodiment of the present invention. The supply chain procurement, settlement and finance system 100 comprises a transaction module 102 for purchasing and receiving goods and services from a supplier, a finance module 104 for providing a financial interest for the goods and services, a settlement module 106 for determining and settling supplier and non-supplier obligations, and a repository 108 for storing buyer data and administration data of the transaction module 102, finance module 104 and settlement module 106. Other components may be added to the supply chain procurement, settlement and finance system 100.

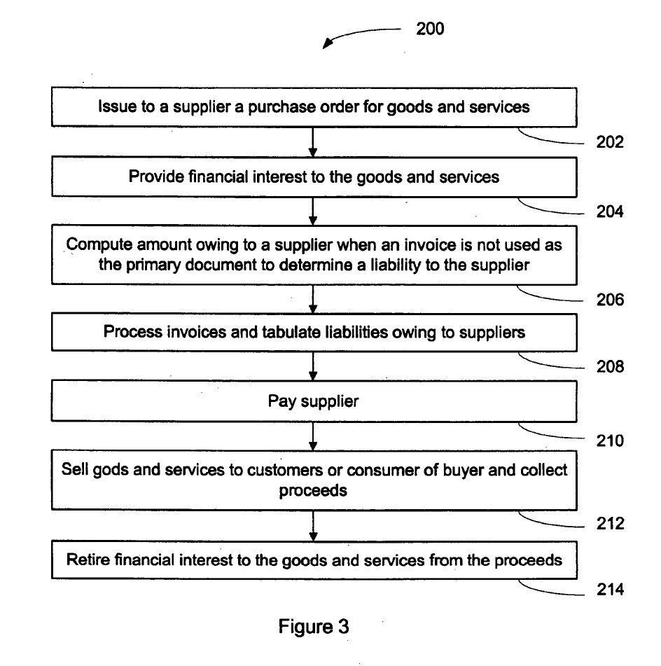

FIG. 3 shows in a flowchart an example of a method of providing procurement and settlement logistics for buyers and financing for suppliers (200), in accordance with an embodiment of the supply chain procurement, settlement and finance system 100. The method (200) begins with issuing to a supplier a purchase order for goods and services (202). Next a financial interest to the goods and services is provided (204). The amount owing to a supplier when an invoice is not used as the primary document is computed to determine a liability to the supplier (206). Next, invoices are processed and liabilities owing to suppliers are tabulated (208). The supplier 14 is paid (210). Next, goods and services are sold to customers and consumers of buyer 12 and proceeds are collected from such sales (212). The financial interest to the goods and services is retired (214).

### DEFINITIONS

The following words or expressions have the following meanings:

Agency Agreement means the agreement between Buyer and Buy-Sell Co. whereby the Buyer has agreed to act as agent for Buy-Sell Co. As agent, Buyer will issue Purchase Orders to Suppliers, receive Goods and Services, verify that Suppliers have performed pursuant to the Purchase Orders, prepare and forward Settlement Details and such other duties as are normally associated with procurement and related process activities. Under the Financing Structure, the Buyer will:
a. Agree to sell the inventories purchased within an agreed number of days following Settlement Day (the “Performance Period”).
b. Purchase from Buy-Sell Co. any unsold inventories remaining at the end of the Performance Period (the “Purchase Covenant”).
c. Pledge its standby-bank facility as collateral to its performance under the Purchase Covenant.

Asset Backed Commercial Paper (ABCP) means the Marketable Securities issued by a Buyer to fund the Cash Deal.

ABCP Agreement means the agreement between the Commercial Paper Dealer and Buy-Sell Co., which agreement defines the terms and conditions for the sale of ABCP by Buy-Sell Co. to the Commercial Paper Dealer to fund the Supplier and Non-Supplier Obligations under the Financing Structure.

Banker's Acceptance (BA) means a bill of exchange or negotiable instrument drawn by the borrower for payment at maturity and accepted by a bank. Banker's Acceptances constitute a guarantee of payment by the bank and can be traded in the money market. The bank earns a “stamping fee”. for providing this guarantee.

Banking Details means the information pertaining to the settlement of Supplier Obligations that has been posted on and is available to Suppliers on the Communications Platform.

Bankruptcy Remote means an SPE that is structured and organized to mitigate the possibility of involuntary insolvency proceedings commenced against it by third-party creditors.

Base Discount Rate means that certain rate applied to determine the discount payable by Suppliers to Buy-Sell Co. for early liquidity at when the Money-Rate in Effect is equal to or less than the Base Floor Rate.

Base Discount Rate Identifier means that certain alphanumeric number attached to each Purchase Order issued by Buy-Sell Co. that identifies the Base Discount Rate that will be referenced to the Discount Rate Matrix in order to compute the Discount payable by the Supplier for early liquidity and determine the Net Supplier Obligation that will be included with the Direct Deposit Details and posted on the Communications Platform.

Base Floor Rate means a stated Money-Rate.

Basis Points (BPS or bps) means 1/100th of a percent.

Buy-Sell Agreement means the agreement between Buyer and Buy-Sell Co. whereby Buy-Sell Co has agreed to purchase Goods and Services from Suppliers as required by Buyer from time to time; or, whereby Buyer has agreed to sell Goods and Services purchased and owned by Buy-Sell Co. to customers or consumers of Buyer.

Buy-Sell Co. means that certain company that is party to a Buy-Sell Agreement that will be organized to
[a] Sell goods and services (supplied or provided by Suppliers pursuant to a Purchase Order) to a Buyer in exchange for Cash or a Promissory Note under the Non-Financing Structure or to consumers or customers of Buyer under the Financing Structure;
[b] Sell such Promissory Note to a Commercial Paper Dealer at a Discount;
[c] Settle obligations to Suppliers early by applying the proceeds in [b] or the Net Cash received from Buyer; and
[d] Earn a finance fee from Suppliers in exchange for [c].
   The Buy-Sell Co. may be organized as a special purpose entity (SPE) that is structured and organized to mitigate the possibility of involuntary insolvency proceedings commenced against it by third-party creditors. SPE means the entity that will purchase Goods and Services from Suppliers pursuant to Purchase Orders and will finance the early payment of Supplier Obligations by issuing ABCP to Commercial Paper Dealers under the Financing Structure.

Buyer means an entity that purchases goods and services from Buy-Sell Co. or agrees to sell goods and services on behalf of Buy-Sell Co. to its customers.

Business Process & Communication Platform means the System's Business Processes and Communication Platform that is employed to receive transaction data, compute settlement amounts with Suppliers and provide banking details and to communicate settlements with Suppliers and Buyers. The Platform consists of a highly available Internet-worked website with operating system, database, integration and security, backup, control, monitoring and web system software in secure physical facilities. This platform interacts with the platforms of participants such as Buyers, Suppliers, Custodians, Trustees, Depositary Banks and Commercial Paper Dealers.

Browser means the program used to access the World Wide Web. It interprets hypertext markup language (HTML) code including text, images, hypertext links, Javascript, and Java applets. After rendering the HTML code, the browser displays a nicely formatted page.

Buy-Sell Expenses means the total of Solution Fees and Finance Costs.

Buy-Sell Profit means Buy-Sell Revenues less Buy-Sell Expenses.

Buy-Sell Revenues means the total of Discounts collected from Suppliers and Outsource Management Fees collected from Buyers.

Cash Deal means the business arrangement between the Buyer and Buy-Sell Co. as defined in the Buy-Sell Agreement requiring the Buyer to pay for Goods & Services provided by Buy-Sell Co. on each Settlement Day plus the Outsource Management Fee.

Cash Discount means the discount deducted from the total of the Face Value of Supplier Obligations and the Outsource Management Fee.

CDOR means the Canadian Dollar Offered Rate, which is, determined daily from a survey of nine market makers in bankers' acceptances (BA). The daily survey of money market rates is derived from bid side prices provided by survey participants. For each maturity band (1-month BA, 2-month BA, 3-month BA, 6-month BA, 1-year BA and call markets), the high and the low rates taken from the survey are removed and a simple arithmetic average is calculated for the remaining survey rates.

Certified Contract Data means copies of Settlement Details (which was originally delivered by the Buyer to the Custodian) that have been electronically signed and numbered as a schedule (“Schedule”) by the Custodian for identification purposes only and forwarded to Buy-Sell Co., the Trustee and the Buyer. The Custodian will attach the Schedules to the Buy-Sell Agreement and will keep such original electronic records for safekeeping.

Commercial Paper means an unsecured, short-term loan issued by a corporation, typically for financing accounts receivable and inventories and usually issued at a discount reflecting prevailing market interest rates.

Commercial Paper Dealer means a financial institution that has entered into a formal relationship with Buy-Sell Co. and has agreed to purchase Promissory Notes from Buy-Sell Co. under certain terms and conditions.

Communications Platform means that portion of the Business Process Platform used to communicate Settlement and Banking Details to Suppliers of Buy-Sell Co.

Contract Liability Memo (CLM) means the electronic document prepared by reference to Purchase Orders and receiving documents to determine the liability owing to a Supplier resulting from the receipt of a shipment of Goods or to the receipt of Services, where such Goods & Services were provided pursuant to a Purchase Order issued by Buy-Sell Co.

Custodian means that business entity (usually a trust company) that is retained by Buy-Sell Co. to be the single authority and gateway for all data and information required to determine and settle Supplier Obligations and to determine and receive appropriate payment from a Buyer. The Custodian is responsible for the receipt, identification and storage and safekeeping of electronically executed Settlement Details, which are identified as a specific schedule under the Buy-Sell Agreement and attached thereto (Schedule) and form part thereof. The Custodian is the single authority and gateway for all data and information required to complete the conversion of goods and services into cash or into Marketable Securities.

Custodian Agreement means the agreement between Custodian and Buy-Sell Co.

Direct Deposit Agreement means the agreement between the Depository Bank and Buy-Sell Co. which agreement defines the rules, process and procedures for the direct deposit of Net Supplier Obligations into Supplier bank accounts maintained with the Depository Bank.

Depositary Bank means that certain bank in which all Suppliers to Buy-Sell Co. will be required to open and maintain a business account for purposes of receiving payment of a Supplier Obligation. Buy-Sell Co. will deposit Net Supplier Obligations directly into bank accounts maintained at the Depository Bank for its Suppliers.

Discount means the amount deducted from the Face Value of a Supplier Obligation in exchange for early payment by Buy-Sell Co.

Discount Rate Matrix means that certain schedule that is referenced by using the Base Discount Rate Identifier and is published on the Web Site organized and maintained for Suppliers of Buy-Sell Co. The Discount Rate Matrix contains the Discount Rate that is applied to a Supplier's Obligation to determine the Discount payable by Suppliers for Early Liquidity as defined in the Purchase Order when the Money-Rate is at a certain yield on a certain Settlement Day.

E-commerce (electronic commerce) refers to business over the Internet. The two major forms of e-commerce are Business-to-Consumer (B2C) and Business-to-Business (B2B).

Electronic Signature Technology means the user authentication technology that meets the criteria for non-refutable electronic contracts.

Encryption means the coding or scrambling of information so that it can only be decoded and read by someone who has the correct decoding key. Encryption is used in secure Web sites as well as other mediums of data transfer. If a third party were to intercept the information you sent via an encrypted connection, they would unable to read the message.

Finance Costs means the costs incurred to fund the early payment of Supplier Obligations. Under the Non-Financing Structure, Financing Costs include the Discount paid to a Buyer under the Cash Deal or the Promissory Note Discount paid to a Commercial Paper Dealer on the sale of the Promissory Note. Under the Financing Structure, Finance Costs include the costs and expenses associated with the issue of ABCP.

Financing Structure means the structure employed by Buy-Sell Co. to finance the early payment of Supplier Obligations, when its agent sells goods and services purchased from Suppliers to consumers or customers of Buyer.

Goods means either inventories purchased for resale or for inputs to value added manufacturing or products and supplies intended for internal consumption.

Internet means a computer network consisting of a worldwide network of computer networks that use the transmission control protocol/Internet protocol (TCP/IP) network protocols to facilitate data transmission and exchange.

Liquidity Costs means the bank stand-by or similar facilities that is pledged as collateral to the payment of the Promissory Notes.

London Interbank Offered Rate (LIBOR) means the international rate that banks use to borrow from each other. LIBOR is the most widely used benchmark or reference rate for short-term interest rates.

Marketable Securities means the ABCP issued by a Buyer to fund the Cash Payment of its obligations on each Settlement Day or by Buy-Sell Co under the Financing Structure.

Money-Rate means the published rate that reflects the term yield on 30-Day and 60-Day CDOR.

Net Supplier Obligation means the Face Value of a Supplier Obligation less the Discount.

Non-Finance Structure means the structure employed by Buy-Sell Co. to finance the early payment of Supplier Obligations when goods and services purchased from Suppliers are sold to the Buyer in exchange for cash or a Promissory Note on each Settlement Day.

Non-Supplier Obligations means those obligations incurred in respect of the management and administration of Buy-Sell Co. These obligations include professional fees, fees payable to the Custodian and Trustee, hosting and systems maintenance costs and expenses, commissions, the fees earned by the Buyer.

Non-Variable Components means the fixed percentages included in the Cash Discount that reflects the cost of a liquidity facility, Rating Agency Fees and the cost of distribution of such securities to the Capital Markets.

Outsource Management Fee means the fee payable by the Buyer under the Non-Financing Structure as compensation for the procurement, settlement and communication services provided by Buy-Sell Co. The Outsource Management Fee is computed as a percent of the Face Value of Supplier Obligations and is paid by Buyer to Buy-Sell Co. on each Settlement Day.

Participation Interest means the interest acquired by the Buyer or a subsidiary of the Buyer in the Buy-Sell Profits of a Buy-Sell Co.

Participation Agreement means the agreement between the Buyer and Buy-Sell Co. whereby Buyer acquires an interest in the Buy-Sell Profits of Buy-Sell Co.

Payment Term & Conditions means those terms and conditions included in a Purchase Order issued to a Supplier. Generally, the Purchase Order will contain two [2] payment terms and conditions:
[a] Normal Payment Term & Condition (established in consultation with Buyer—this normal term will mirror the Buyer's traditional payment terms before the relationship with Buy-Sell Co.); and
[b] Early Payment Term—generally this term will be equal to the Settlement Day and will give Buy-Sell Co. the right to take a discount as defined elsewhere in the Purchase Order or by reference to a Website maintained by Buy-Sell Co. for such a purpose.

Program Manager means the company retained by Buy-Sell Co. to manage and administrate those activities not otherwise performed by the Trustee.

Promissory Note means a negotiable instrument received by Buy-Sell Co. as consideration for goods and services sold to a Buyer and as compensation for the Outsource Management Fee. Preferably, Canadian Banks or AAA Rated Insurance Companies will underwrite the performance of such Promissory Note.

Promissory Note Sale Agreement means the agreement between Commercial Paper Dealer and Buy-Sell Co. which agreement defines the terms and conditions for the sale of the Promissory Notes received by Buy-Sell Co. from time to time from Buyer to Commercial Paper Dealer.

Promissory Note Discount means the discount that will be deducted by the Commercial Paper Dealer from the Purchase Price of the Promissory Note received by Buy-Sell Co. as consideration for the sale of goods and services and then sold by the Buy-Sell Co. to the Commercial Paper Dealer or similar organization.

Purchase Order means the contractual agreement with a Supplier of Goods or Services that specifies payment terms, delivery dates, item identification, quantities, freight terms and all other obligations and conditions. The right to take a discount in exchange for early payment will be a term and condition of all Purchase Orders issued by Buy-Sell Co.

Purchase Price means the amount payable by the Commercial Paper Dealer for a Promissory Note that is equal to the Face Value of Promissory Note less the Promissory Note Discount.

Rating Agency means the company that is engaged in the evaluation of securities issued either by the Buyer to finance the Cash Deal, the Promissory Notes issued by the Buyer under the Non-Financing Structure and the ABCP issued under the Financing Structure. Rating Agencies include companies such as Standard & Poor, Moodys and Fitch.

Repository means a relational database employed to convert and translate the Contract Data into useable fields of information, to compute a Discount payable by suppliers, to prepare settlement details for payment of supplier obligations, to store asset details and to collect information regarding the sale of Goods & Services to a Buyer and to provide the summary data and information into the transaction module and the settlement module.

Server serves information to computers that connect to it. When users connect to a server, they can access programs, files, and other information from the server. Common servers are Web servers, mail servers, and local area network (LAN) servers. A single computer can have several different server programs running on it.

Services means those non-Goods ordered by a Buyer.

Settlement Appliance means a multi-function device consisting of computer and network hardware, operating system software, application, network and compatibility software, and an information/business rules repository. It automatically aggregates data from a buyer's systems, processes it and transmits it to Buy-Sell Co.'s business system. This may be installed by Buyers to expedite business processing and communication with the Buyer's subsystems.

Settlement Day means the day on which Supplier Obligations are paid. The intention is to have the Settlement Day be equal to the Trade Day +1 Business Day.

Settlement Details means the information and data prepared by Buyer and sent to Custodian for identification and warehousing. In the case of an Invoice Based System, the data includes invoice amount, invoice number, Date of invoice and Purchase Order Number. In the case of an Invoice Free System, the data includes CLM amount, CLM number, Date of CLM, Purchase Order Number, Receiving References, Supplier Shipping References and CLM Details. In the communication of Settlements to Suppliers, the difference between the two systems is the level of details that will be provided to Suppliers. In an Invoice Free System, the CLM Details are communicated as a second layer of information that will permit the Supplier to verify and confirm the accuracy of payment of a certain shipment made. This level of detail is not required in an Invoice Based System since the Supplier has already furnished such information in the invoice previously issued.

Solutions Fees means the fee payable to the Program Manager pursuant to the Program Management Agreement. The Solution Fees will be computed and paid to the Program Manager on each Settlement Day.

Supplier means an entity that has sold Goods and/or Services to Buy-Sell Co.

Supplier Obligation means the face value of an obligation due to a Supplier where such Supplier has sold Goods or provided Services to Buy-Sell Co. pursuant to a Purchase Order.

Technology Requirements means some or all of the following:
Settlement Appliance installed by the Buyer
Virtual Private Network (VPN)
Electronic Signature Technology
Repository
Business Process & Communication Platform
Internet Service Provider (ISP)—Used by all parties.
Email
Methods for computing Discounts
Personal Computer Hardware and Software Configurations including some or all of the following: a current web browser (preferably 128 bit encryption), VPN access, standard email, Internet access and electronic signature tools.
Off-the-shelf accounting software

Trade Day means the day that the Supplier either delivered Goods or provided Services under a Purchase Order.

Transaction Structure means either the Financing Structure or the Non-Financing Structure.

Term Deal means the business arrangement between the Buyer and Buy-Sell Co. as defined in the Buy-Sell Agreement requiring the Buyer to deliver a Non-Interest Bearing Promissory Note as consideration to Buy-Sell Co. on each Settlement Day.

Trustee means that certain business engaged by Buy-Sell Co. to perform those services normally provided by a Corporate Trustee, which will include responsibility for the collection of proceeds, settlement of Supplier and Non-Supplier Obligations and communication of settlement activities to relevant parties.

Trustee Agreement means the agreement between Trustee and Buy-Sell Co.

VPN means Virtual Private Network. The use of encryption in the lower protocol layers (of the 7 layer ISO network definition model) to provide a secure connection through an otherwise insecure network, typically the Internet. The System may use VPNs and or real private networks using private lines that may rely on having the same encryption system with all parties. The encryption may be performed by firewall software or by routers.

Variable Component means the Term Money-Rate in Effect.

Web Page is a document that is written in hypertext markup language (HTML) and is translated by a Web browser. Web pages can either be static or dynamic. Static pages show the same content each time they are viewed. Dynamic pages have content that can change each time they are accessed.

Website is a collection of Web pages. For example, Amazon.com is a Web site, but there are millions of Web pages that make up the site.

Modes of Operating Structures

In one embodiment of the supply chain procurement, settlement and finance system 100, the system 100 includes two modes of operating structures for financing or funding supplier obligations. A non-financing structure is used when a buyer enters into a Buy-Sell Agreement with a Buy-Sell Co. formed and organized for each agreement. Such Buy-Sell Co. will:
[a] Purchase Goods and Services from Suppliers pursuant to Purchase Orders issued by the Buy-Sell Co.;
[b] Sell the Goods and Services described in [a], above, to the Buyer on the Settlement Day;
[c] Collect from the Buyer either Cash less a Cash Discount or a Promissory Note equal to the total of the Face Value of Supplier Obligations and Outsource Management Fee (In the case where a Promissory Note was received as settlement, Buy-Sell Co. will sell such Promissory Note to a Commercial Paper Dealer.); and
[d] Charge Suppliers a Discount (as such term is defined in each Purchase Order) in exchange for such early payment and settle such Supplier Obligations by applying the proceeds collected in [c], above.
   A financing structure is used when a special purpose entity (SPE) is formed and organized for each Supply Chain that adopts the system 100. Such SPE will:
[a] Purchase Goods and Services from Suppliers pursuant to Purchase Orders issued by the SPE;
[b] Engage a Buyer to sell such Goods and Services to consumers as agent for the SPE;
[c] Issue Asset Backed Securities to the Capital Markets to finance the early payment of Supplier Obligations; or alternatively call on a finance facility to finance the early payment of Supplier Obligations;
[d] Charge Suppliers a Discount in accordance with the terms of the Purchase Order in exchange for such early payment; and
[e] Collect the proceeds from the sale of the Goods and Services and repay the Asset Backed Securities previously issued.
   Furthermore, the cost of processing invoices is in today's marketplace no longer a requirement in order to establish a liability to a supplier by the purchasing buyer. The cost incurred by a buyer to verify the accuracy and validity of a suppliers invoice is the range of $10.00-$20.00 per invoice issued. Similarly, the cost of preparing, issuing and delivering an invoice to a buyer by a supplier is estimated to cost $10.00-$20.00 per invoice issued.

Preferably, under the supply chain procurement, settlement and finance system 100:
All Goods and Services will be purchased pursuant to a Purchase Order.
All liabilities will be determined by reference to quantities of Goods and Services received and verified, the prices contracted for and the value added taxes payable by reference to the previously issued Purchase Orders. The Discount Rate applied to Supplier Obligations will be a Term and Condition of the Purchase Order.
Ideally, invoices will not be processed.
The Buyer will avoid the expense of processing Invoices—estimated to be $10-$20 per Invoice.
The Suppliers to Buy-Sell Co will avoid the cost of preparing, processing and delivering Invoices—also estimated to be $10-$20 per Invoice.
   The Non Financing Structure

Under the Non-Financing Structure, the Buyer enters into a Buy-Sell Agreement:
To purchase goods and services using the system 100; and,
To pay for such Goods and Services on the Settlement Day.
   A separate company [“Buy-Sell Co”] is formed and organized to manage and administer each Buy-Sell Agreement with buyers 12. The buyer 12 pays for the goods and services in one of two [2] ways:

1) The Cash Deal
The buyer pays an amount equal to the Face Value of Supplier Obligations less a Cash Discount [the “Cash Deal”]. In one embodiment, the Cash Deal Business Structure assumes that the Buyer will finance its obligation by issuing Commercial Paper to the Capital Markets. The Cash Discount deducted from the Face Value of Supplier Obligations is structured to approximate the buyer's 12 cost of funds incurred from issuing Commercial Paper to fund the Cash Deal.

2) The Term Deal
The buyer 12 delivers a non-interest 30-Day or 60-Day Promissory Note (typically guaranteed by a bank 16) equal to the Face Value of Supplier Obligations. Under the Term Deal, Buy-Sell Co. sells the Promissory Note at a discount (the “Promissory Note Discount”) to a Commercial Paper Dealer. Buy-Sell Co applies the proceeds from the sale of the Promissory Note to settle supplier 14 and other obligations.
   Outline of Process Steps for the Non-Financing Structure
   Cash Deal:

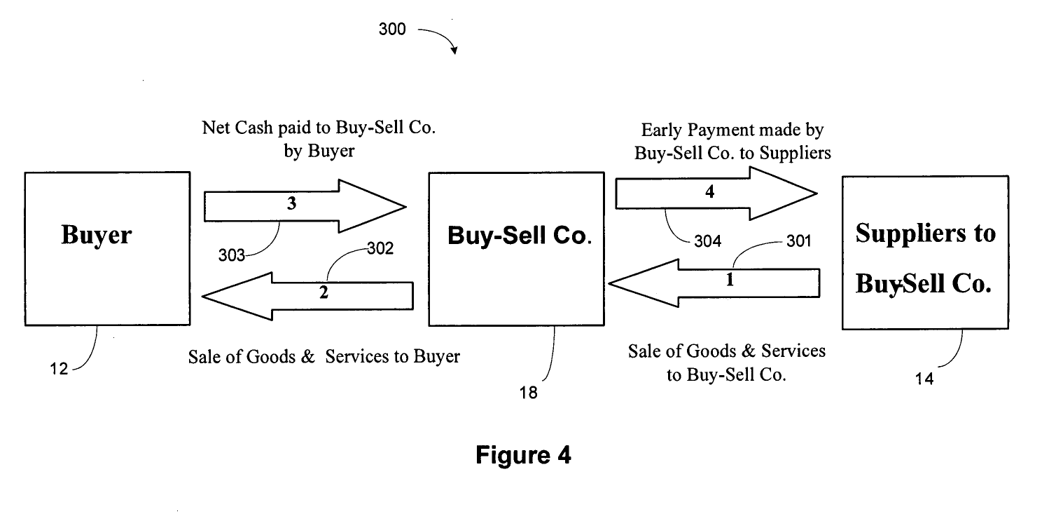

FIG. 4 shows in a process flow diagram an example of a method of a non-financing cash deal (300), in accordance with an embodiment of the supply chain procurement, settlement and finance system 100. The method (300) comprises the steps of:
(301) Suppliers 14 delivers Goods & Services based upon Purchase Orders received from Buy-Sell Co. 18. Purchase Orders are based upon instructions received from a buyer 12.
(302) The Goods & Services are then sold (and shipped directly) to the buyer 12.
(303) The buyer 12 pays an amount equal to the Face Value of Supplier Obligations less a Cash Discount (the “Cash Deal”).
(304) Buy-Sell Co. 18 pays its suppliers 14 early, at a Discount determined by reference to terms and conditions contained in the Purchase Orders.
   Term Deal:

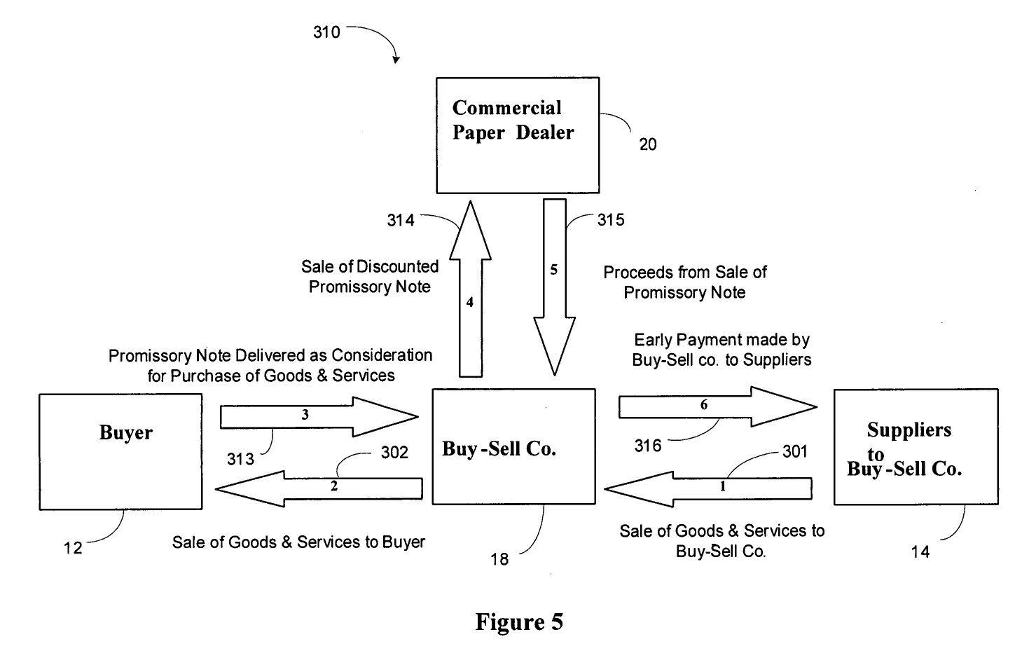

FIG. 5 shows in a process flow diagram an example of a method of a non-financing term deal (310), in accordance with an embodiment of the supply chain procurement, settlement and finance system 100. The method (310) comprises the steps of:
(301) Suppliers 14 delivers Goods & Services based upon Purchase Orders received from Buy-Sell Co. 18. Purchase Orders are based upon instructions received from a buyer 12.
(302) The Goods & Services are then sold (and shipped directly) to the buyer 12.
(313) Buyer 12 delivers a transferable 30 or 60-day Promissory Note.
(314) Buy-Sell Co. 18 sells the Promissory Note at a discount (the “Net Selling Price”).
(315) Buy-Sell Co. 18 receives the Net Selling Price.
(316) Buy-Sell Co. 18 pays its suppliers 14 early, at a Discount determined by reference to terms and conditions contained in the Purchase Orders.
   Outline of Process Steps for the Financing Structure

In addition to the Non-Financing Structure, the system 100 also includes a Financing Structure, which entails the issue of ABCP to finance the payment of supplier 14 and Non-Supplier Obligations. Although somewhat more complex, the financial and operating benefits for buyers 12 and suppliers 14 are almost the same as under the Non-Financing Structure. However, this Solution does remove operating inventories from the books of retailers.

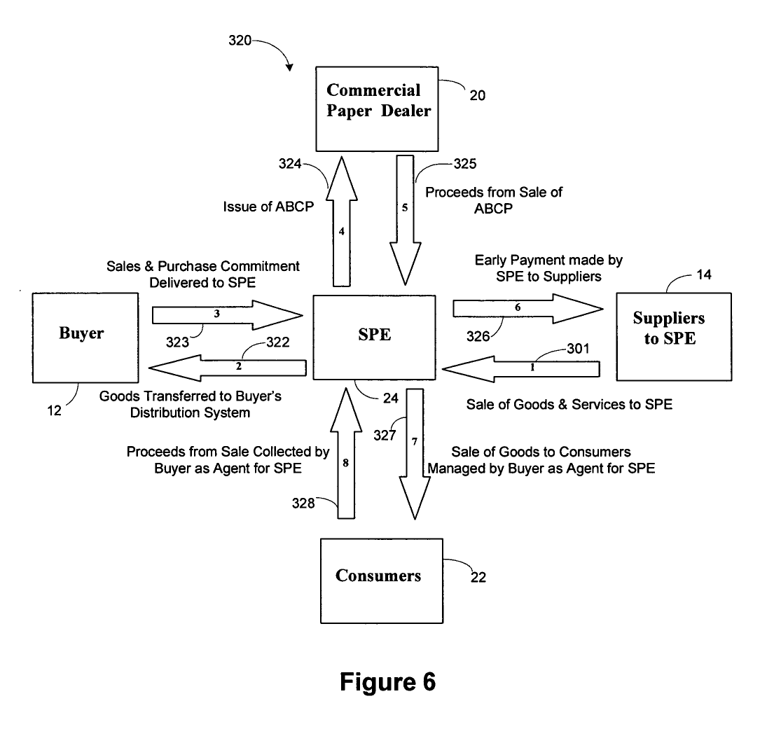

FIG. 6 shows in a process flow diagram an example of a method of a financing deal (320), in accordance with an embodiment of the supply chain procurement, settlement and finance system 100. The method (320) comprises the steps of:
(301) Suppliers 14 delivers Goods & Services based upon Purchase Orders received from Buy-Sell Co. 18. Purchase Orders are based upon instructions received from a buyer 12.
(322) Goods delivered by suppliers 14 to Participating buyer 12.
(323) Participating buyer 12 delivers Sales & Unsold Goods and Services Purchase Commitment to SPE 24.
(324) SPE 24 sells ABCP to Commercial Paper Dealer 20 (or calls and draws on a commercial finance facility).
(325) SPE 24 receives Net Proceeds from sale of ABCP (or receives proceeds under a commercial finance facility).
(326) Supplier 14 and other obligations settled.
(327) Inventories sold to consumers 22.
(328) Proceeds from sale of Inventories collected and applied to retire ABCP.
   Roles of the Participants
   The Buyer as Agent

As agent for Buy-Sell Co. 18, the buyer 12:
Maintains all master contract files of suppliers 14, including banking information and direct deposit information.
Prepares and issues Purchase Orders to suppliers 14 for all purchases made by Buy-Sell Co. 18.
Verifies and confirms that suppliers 14 have fulfilled all or certain of their obligations.
Prepares a Contract Liability Memo (CLM) for each shipment received pursuant to a Purchase Order, which CLM will detail the nature of the liability due to a supplier 14, including relevant references (such as purchase order number, supplier 14 shipping references, date of receipt, buyer 12 receiving references, etc.).
Forward, on a daily basis, all CLMs and a summary by the supplier 14 of such CLMs (the “CLM Summary”) (in total, the “Settlement Details”) to Buy-Sell Co. 18 for processing and settlement.
   The Role of the Trustee

Under the Cash Deal, the Trustee will [a] receive the Cash from the buyer 12 as Settlement of a Trade; and [b] pay supplier 14 and other related Obligations.

Under the Term Deal, the Trustee will [a] take delivery of the Promissory Notes issued by the buyer 12 as agent; [b] sell the Promissory Notes to a Commercial Paper Dealer 20; and [c] pay supplier 14 and other related Obligations.

The Business Process and Communication Platform

Buy-Sell Co. 18 employs a principal web-based platform to communicate all Settlement and Banking Details to suppliers 14 on each Settlement Day.

The Role for Commercial Paper Dealers

Under the Non-Financing Structure, Buy-Sell Co. 18 enters into a Promissory Note Sales Agreement with Commercial Paper Dealers 20. The Commercial Paper Dealers 20 purchase the Promissory Notes, at a discount, conditional upon such Promissory Notes being guaranteed by banks 16. The Net Selling Price of the Promissory Notes will be applied to find the payment of supplier 12 and Non-Supplier Obligations.

Under the Financing Structure, Buy-Sell Co. 18 enters into an ABCP Agreement with Commercial Paper Dealers 20 to purchase the ABCP to fund the payment of supplier 14 and Non-Supplier Obligations.

System 100 Components

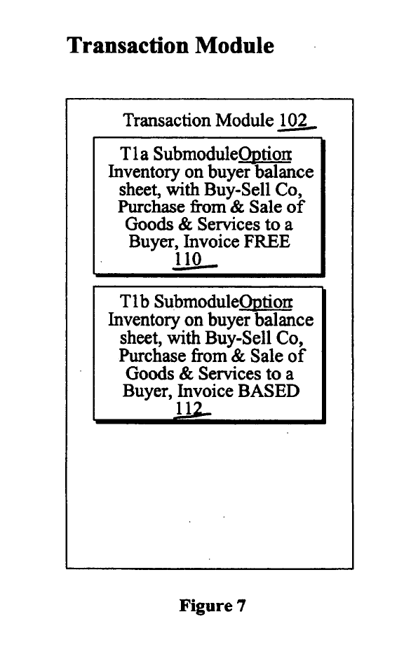

FIG. 7 shows in a block diagram an example of a transaction module 102, in accordance with an embodiment of the supply chain procurement, settlement and finance system 100. The transaction module 102 includes one or more of an invoice free transaction submodule 110 for operating the transaction module 102 when invoices are not required to establish the liability due to a supplier 14 that has shipped goods or provided services to Buy-Sell Co. 18 pursuant to a Purchase Order, and an invoice based financing transaction submodule 112 for operating the transaction module 102 when invoices are required in order to establish the liability due to a supplier 14 who has shipped goods or provided services to Buy-Sell Co. 18 pursuant to a Purchase Order.

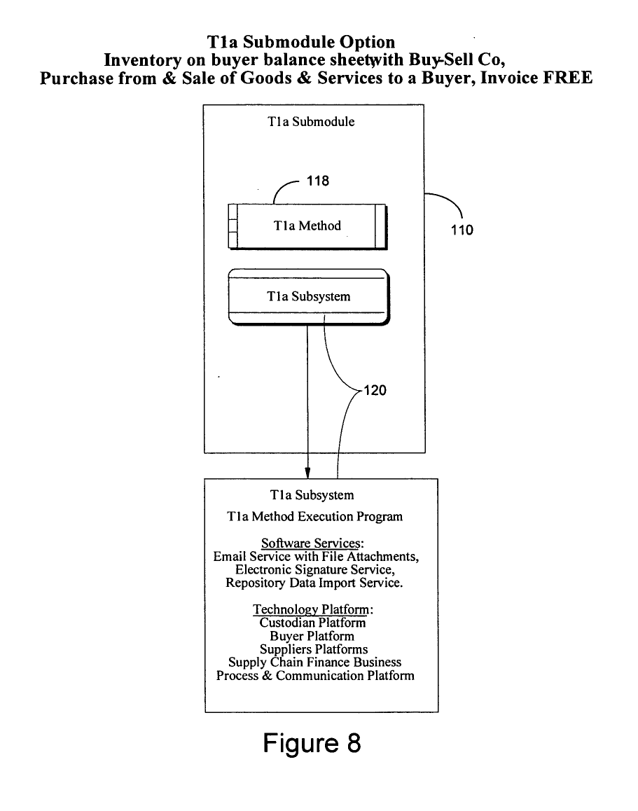

FIG. 8 shows in a block diagram an example of an invoice free transaction submodule 110, in accordance with an embodiment of the supply chain procurement, settlement and finance system 100. The invoice free financing transaction submodule 110 includes a memory for storing computer readable code representing invoice free transaction methods 118 (or a set of instructions) for electronically performing the following tasks:
1. As agent for Buy-Sell Co. 18, buyer 12 prepares and issues Purchase Orders to suppliers 14 in name of Buy-Sell Co. 18, and buyer 12 maintains all relevant Supplier Master Files. The buyer 12 negotiates, on behalf of Buy-Sell Co. 18, a Base Discount payable by suppliers 14 for early liquidity. The right to deduct a discount from the amount otherwise payable under a Purchase Order will be a right included with the Terms and Conditions in each Purchase Order issued to suppliers 14. The Discount Payable by suppliers 14 is indexed to the movement of Money-Rates over a Base Floor Rate. Each Purchase Order issued contains a Base Discount Rate Identifier that is employed to compute the amount of the discount payable by suppliers 14 in exchange for early payment of an obligation arising from completion of the Terms and Conditions contained in a Purchase Order issued by Buy-Sell Co. 18.
2. Buyer 12 agrees and warrants, under the Buy-Sell Agreement, to purchase from Buy-Sell Co. 18 the same goods and services as ordered from suppliers 14.
3. Supplier 14 receives Purchase Orders and ships goods or provides services. In the case of goods, the suppliers 14 ship directly to buyer's 12 facilities. Shipping and routing instructions are a component part of the Purchase Order issued by Buy-Sell Co. 18 to suppliers 14. Supplier 14 provides bar-code information on shipment or other suitable information (the “Shipping Data”). In addition to product descriptions, product codes and units shipped, the Shipping Data also includes relevant references to purchase order number, supplier 14 shipping references, date of shipment, etc.
4. As agent for Buy-Sell Co. 18, buyer 12 records Shipping Data and relevant receiving documentation (collectively, the “Performance Data”).
5. Buyer 12 prepares a Contract Liability Memo (CLM) for each receiving transaction by reference to the Performance Data and the underlying Purchase Order issued to suppliers 14. The CLM contains a Base Discount Rate Identifier supplied by Buy-Sell Co. and published in its website for reference by suppliers 14. The Base Discount Rate Identifier is employed by the Buy-Sell Co. 18 to calculate the Discount payable by suppliers 14 in exchange for early payment.
6. Buyer 12 prepares a listing of all CLM processed in the case of an Invoice Free System or (the “Settlement Details”). The Settlement Details will include all appropriate folio references, including the Base Discount Rate Identifier.
7. Buyer 12 electronically signs the Settlement Details and forwards same to a Custodian.
8. Custodian time and date stamps the Settlement Details, appends a unique alpha numeric identity, signs the Settlement Details for identification purposes only and holds in safekeeping the Settlement Details as a Schedule to the Buy-Sell Agreement.
9. Custodian forwards a copy of the Schedule to the Trustee and the buyer 12 and the Program Manager.
   The invoice free financing transaction submodule 110 also includes invoice free financing architecture components 120 for providing communication between participants in the supply chain procurement, settlement and finance system 100. The invoice free financing architecture components 120 include an invoice free transaction method invoker (or program) for invoking the invoice free transaction methods 118, software services including an email service, an electronic signature service and a repository data import service, and technology platform including a custodian platform, a buyer 12 platform, supplier 14 platforms, supply chain finance business process & communication platform.

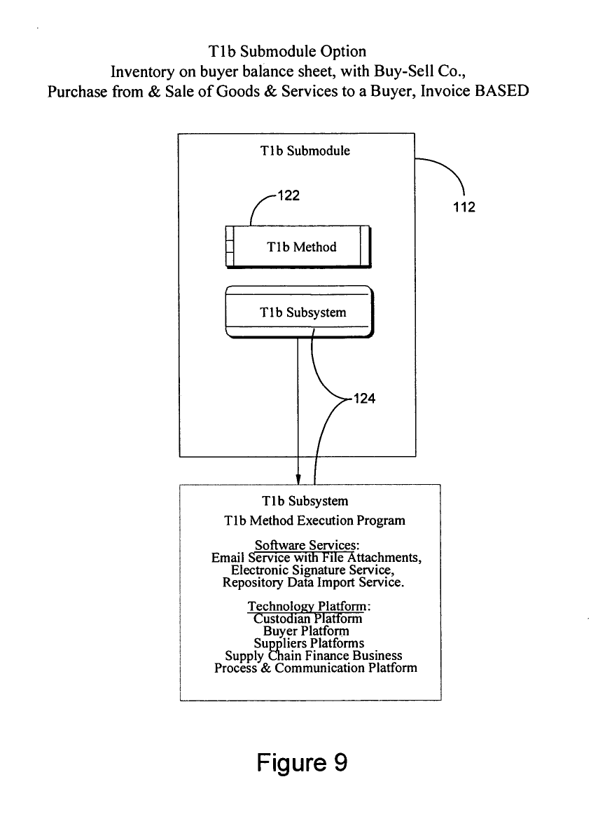

FIG. 9 shows in a block diagram an example of an invoice based transaction submodule 112, in accordance with an embodiment of the supply chain procurement, settlement and finance system 100. The invoice based financing transaction submodule 112 includes a memory for storing computer readable code representing invoice based transaction methods 122 (or a set of instructions) for electronically performing the following tasks:
1. As agent for Buy-Sell Co. 18, buyer 12 prepares and issues Purchase Orders to suppliers 14 in name of Buy-Sell Co. 18, and buyer 12 maintains all relevant Supplier Master Files. The buyer 12 negotiates, on behalf of Buy-Sell Co. 18, a Base Discount payable by suppliers 14 for early liquidity. The right to deduct a discount from the amount otherwise payable under a Purchase Order will be a right included with the Terms and Conditions in each Purchase Order issued to suppliers 14. The Discount Payable by suppliers 14 is indexed to the movement of Money-Rates over a Base Floor Rate. Each Purchase Order issued contains a Base Discount Rate Identifier that is employed to compute the amount of the discount payable by suppliers 14 in exchange for early payment of an obligation arising from completion of the Terms and Conditions contained in a Purchase Order issued by Buy-Sell Co. 18.
2. Buyer 12 agrees and warrants, under the Buy-Sell Agreement, to purchase from Buy-Sell Co. 18 the same goods and services as ordered from suppliers 14.
3. Supplier 14 receives Purchase Orders and ships goods or provides services. In the case of goods, the suppliers 14 ship directly to buyer's 12 facilities. Shipping and routing instructions are a component part of the Purchase Order issued by Buy-Sell Co. 18 to suppliers 14. Supplier 14 provides bar-code information on shipment or other suitable information (the “Shipping Data”). In addition to product descriptions, product codes and units shipped, the Shipping Data also includes relevant references to purchase order number, supplier 14 shipping references, date of shipment, etc.
4. As agent for Buy-Sell Co. 18, buyer 12 records Shipping Data and relevant receiving documentation (collectively, the “Performance Data”).
5. Supplier 14 prepares and delivers an Invoice to buyer 12 as agent for Buy-Sell Co. 18.
6. Buyer 21 compares details contained in the Invoice received to receiving documents, to the Purchase Order issued and verifies the validity of the units billed and the accuracy of the amount included on the Invoice and the related value added taxes.
7. In the case of an error or incorrect invoice, the buyer 12 returns the Invoice to the supplier 14 for correction.
8. Buyer 12 prepares a listing of approved Invoices (the “Settlement Details”). The Settlement Details include all appropriate folio references, including the Base Discount Rate Identifier.
10. Buyer 12 electronically signs the Settlement Details and forwards same to a Custodian.
11. Custodian time and date stamps the Settlement Details, appends a unique alpha numeric identity, signs the Settlement Details for identification purposes only and holds in safekeeping the Settlement Details as a Schedule to the Buy-Sell Agreement.
12. Custodian forwards a copy of the Schedule to the Trustee and the buyer 12 and the Program Manager.
   The invoice based financing transaction submodule 110 also includes an invoice based financing architecture components 124 for providing communication between participants in the supply chain procurement, settlement and finance system 100. The invoice based financing architecture components 124 include an invoice based transaction method invoker (or program) for invoking the invoice based transaction methods 122, software services and technology platforms similar to those of the invoice free financing architecture 120.

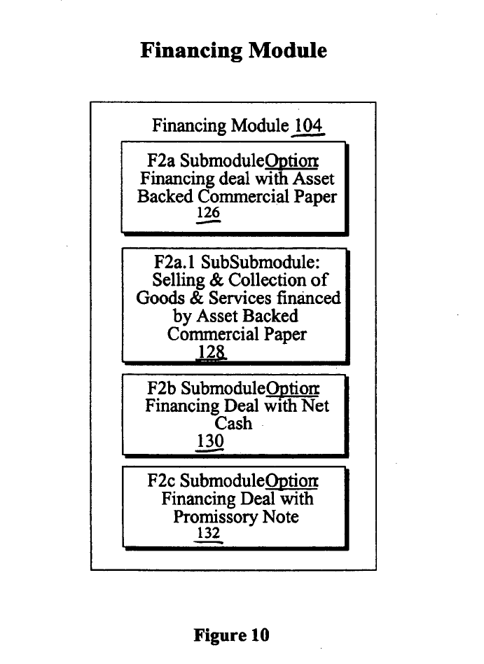

FIG. 10 shows in a block diagram an example of a finance module 104, in accordance with an embodiment of the supply chain procurement, settlement and finance system 100. The finance module 104 includes one or more of an asset backed commercial paper financing submodule 126 for operating the financing structure of the finance module 104 for a transaction requiring the issue and sale of ABCP to Commercial Paper Dealers 20, an asset backed commercial paper sales and collection submodule 128 for operating the financing structure of the finance module 104 to collect goods and services sold to customers of buyer 12 and to repay the ABCP issued by the asset backed commercial paper financing submodule 126, a cash payment submodule 130 for operating the Non-Financing Structure of the transaction module 104 when goods and services are sold to buyers 12 for Cash, and a promissory note submodule 132 for operating the Non-Financing Structure of the transaction module 104 when goods and services are sold to buyers 12 in exchange for Promissory Notes.

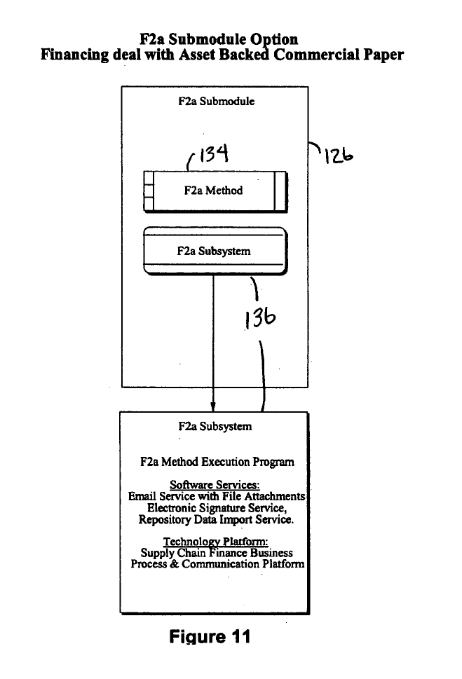

FIG. 11 shows in a block diagram an example of an asset backed commercial paper financing submodule 126, in accordance with an embodiment of the supply chain procurement, settlement and finance system 100. The asset backed commercial paper financing submodule 126 includes a memory for storing computer readable code representing asset backed commercial paper financing methods 134 (or a set of instructions) for electronically performing the following tasks:
1. The Trustee, by reference to the copy of the Schedule, notifies the Commercial Paper Dealer 20 on the Trade Day that a Trade has been concluded and the amount of the ABCP to be issued and settled on the Settlement Day pursuant to the ABCP Agreement. The means of notification and communication (whether by email or by facsimile) used by the Trustee to the Commercial Paper Dealer 20 is determined by the parties and is an operating rule and procedure under either the ABCP Agreement or the Promissory Note Sale Agreement.
   The asset backed commercial paper financing submodule 126 also includes asset backed commercial paper financing architecture components 136 for providing communication between participants in the supply chain procurement, settlement and finance system 100. The asset backed commercial paper financing architecture components 136 include an asset backed commercial paper financing method invoker (or program) for invoking the asset backed commercial paper financing methods 134, software services including an email service with file attachments, an electronic signature service, and a repository data import service, and technology platforms including a supply chain finance business process & communication platform.

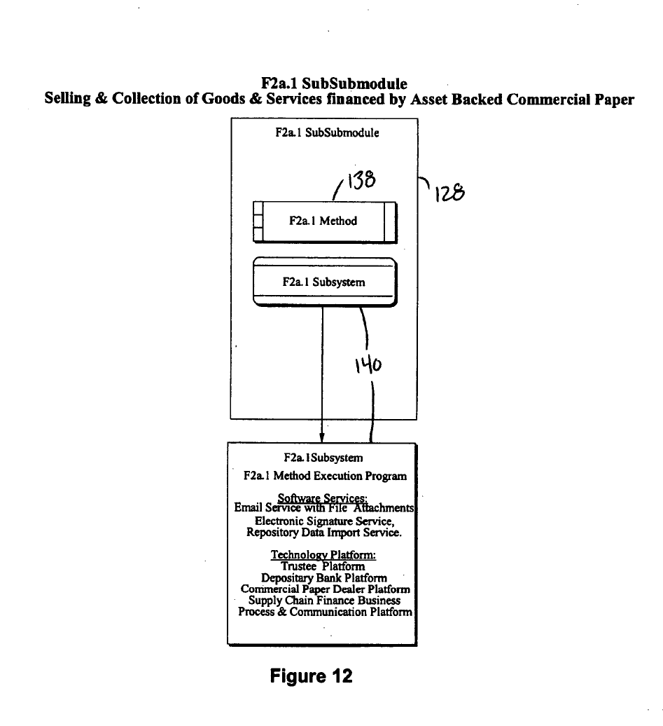

FIG. 12 shows in a block diagram an example of an asset backed commercial paper sales and collection submodule 128, in accordance with an embodiment of the supply chain procurement, settlement and finance system 100. The asset backed commercial paper sales and collection submodule 128 includes a memory for storing computer readable code representing asset backed commercial paper sales and collection methods 138 (or a set of instructions) for electronically performing the following tasks:
1. The Trustee sells ABCP to Commercial Paper Dealers 20 to fund the early payment of Supplier Obligations purchased to be sold to customers or consumers of buyer 12. On the Trade Day, Trustee notifies the Commercial Paper Dealer 20 of the Face of the ABCP to issued and sold pursuant to the ABCP Agreement. On the Settlement Day, the Commercial Paper Dealer 20 affects a transfer of the proceeds into the bank account maintained by Trustee on behalf of Buy-Sell Co. 18.
   The asset backed commercial paper sales and collection submodule 128 also includes asset backed commercial paper sales and collection architecture components 140 for providing communication between participants in the supply chain procurement, settlement and finance system 100. The asset backed commercial paper sales and collection architecture components 140 include an asset backed commercial paper sales and collection method invoker (or program) for invoking the asset backed commercial paper sales and collection methods 138, software services including an email service with file attachments, an electronic signature service, and a repository data import service, and technology platforms including a trustee platform, a depository bank platform, a commercial paper dealer platform, and a supply chain finance business process & communication platform.

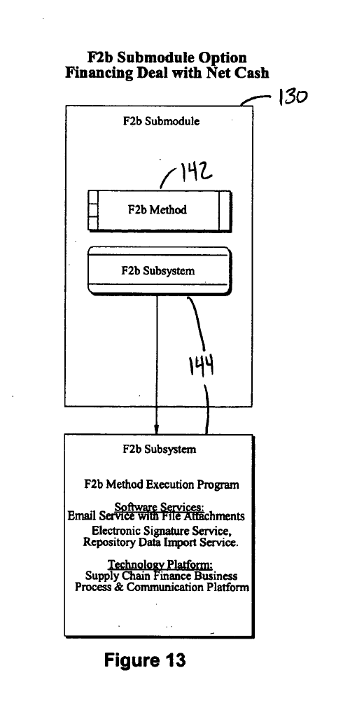

FIG. 13 shows in a block diagram an example of a cash payment submodule 130, in accordance with an embodiment of the supply chain procurement, settlement and finance system 100. The cash payment submodule 130 includes a memory for storing computer readable code representing cash payment methods 142 (or a set of instructions) for electronically performing the following tasks:
1. The Trustee determines the Money-Rate in Effect on the Settlement Day, which Money-Rate is referenced in order to determine the Cash Discount payable when the buyer 12 settles its purchase obligations to Buy-Sell Co. 18 in Cash. On the Settlement Day, the buyer 12 pays the Net Cash as consideration for the Face Value of Supplier Obligations included in the Schedule. The Business Structure assumes that the buyer 12 issues Commercial Paper to find the payment of its obligations under the Cash Deal. The Cash Discount is intended to represent a re-imbursement of the finance costs and expenses incurred by the buyer 12.
2. If the Terms of Settlement with the buyer 12 requires payment of Cash on Closing, the buyer 12 computes the Cash Obligation by deducting the Cash Discount from the Face Value of Supplier Obligations contained in the CLMs. The Non-Variable Components of the Cash Discount are defined in the Buy-Sell Agreement executed by the buyer 12 and Buy-Sell Co. 18. The Variable Component of the Cash Discount will be the Money-Rate in Effect on the Settlement Day.
   The cash payment submodule 130 also includes cash payment architecture components 140 for providing communication between participants in the supply chain procurement, settlement and finance system 100. The cash payment architecture components 144 include a cash payment method invoker (or program) for invoking the cash payment methods 142, software services including an email service with file attachments, an electronic signature service, and a repository data import service, and technology platforms including a supply chain finance business process & communication platform.

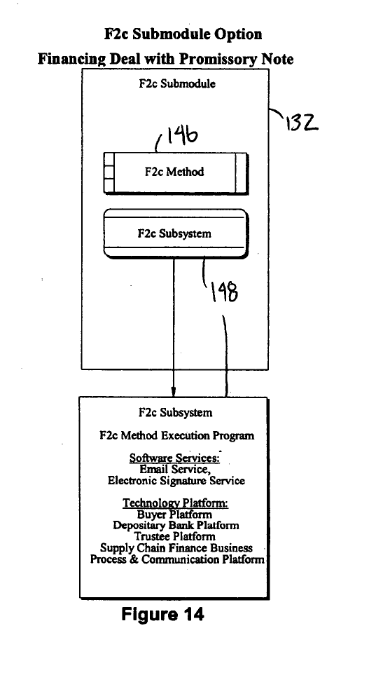

FIG. 14 shows in a block diagram an example of a promissory note finance submodule 132, in accordance with an embodiment of the supply chain procurement, settlement and finance system 100. The promissory note finance submodule 132 includes a memory for storing computer readable code representing promissory note finance methods 146 (or a set of instructions) for electronically performing the following tasks:
1. The Trustee advises the Commercial Paper Dealer 20 on the Trade Day that a Promissory Note has been received, the Face Value of such Promissory Note and that the sale of such Promissory Note will be made on the Settlement Day pursuant to the Promissory Note Sale Agreement. The means of notification and communication (whether by email or by facsimile) used by the Trustee to the Commercial Paper Dealer 20 is determined by the parties and is an operating rule and procedure under either the ABCP Agreement or the Promissory Note Sale Agreement.
   The promissory note finance submodule 132 also includes promissory note finance architecture components 148 for providing communication between participants in the supply chain procurement, settlement and finance system 100. The promissory note finance architecture components 148 include a promissory note method invoker (or program) for invoking the promissory note methods 146, software services including an email service, and an electronic signature service, and technology platforms including a buyer platform, a depository bank platform, a trustee platform, and a supply chain finance business process & communication platform.

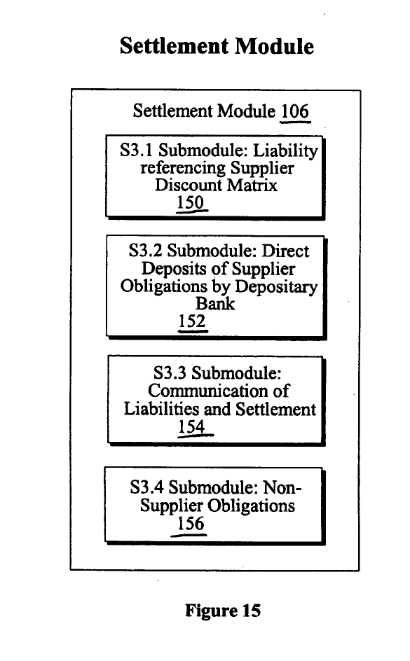

FIG. 15 shows in a block diagram an example of a settlement module 106, in accordance with an embodiment of the supply chain procurement, settlement and finance system 100. The settlement module 106 includes a liability referencing supplier discount matrix submodule 150 for determining and computing the Discount payable by suppliers 12 in exchange for early payment of Supplier Obligations, a direct deposits of supplier obligations by depository bank submodule 152 for effecting a direct deposit of Supplier Obligations into bank accounts maintained by suppliers 14 at Depositary Bank, a communication of liabilities and settlement submodule 154 for communicating Settlement and Deposit details to suppliers 14, and a non-supplier obligations submodule 156 for determining and effecting payment of Non-Supplier Obligations.

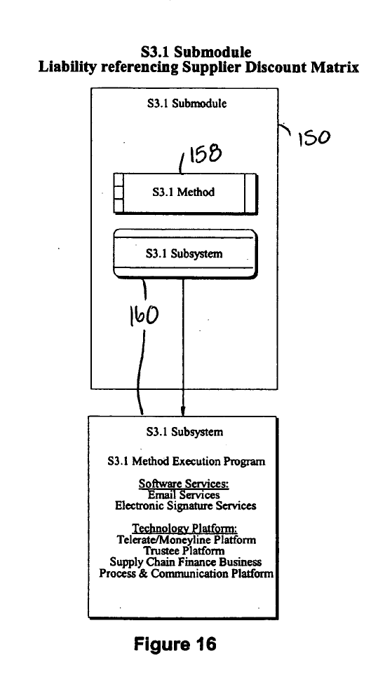

FIG. 16 shows in a block diagram an example of a liability referencing supplier discount matrix settlement submodule 150, in accordance with an embodiment of the supply chain procurement, settlement and finance system 100. The liability referencing supplier discount matrix settlement submodule 150 includes a memory for storing computer readable code representing liability referencing supplier discount matrix settlement methods 158 (or a set of instructions) for electronically performing the following tasks:
1. Trustee, by reference to the Money-Rate in Effect, the Base Discount Rate Identifier and the relevant Discount Matrix, computes the Discount to be deducted from the Supplier Obligation and the Net Supplier Obligation owing for all suppliers 14 included in the Schedule. Trustee uses authorized external website for money rates and Buy-Sell Co.'s Business Process & Communication Platform for relevant discount matrix. Trustee will use Buy-Sell Co.'s unique Methods for computing Discounts.
   The liability referencing supplier discount matrix settlement submodule 150 also includes liability referencing supplier discount matrix settlement architecture components 160 for providing communication between participants in the supply chain procurement, settlement and finance system 100. The liability referencing supplier discount matrix settlement components 160 include a liability referencing supplier discount matrix settlement method invoker (or program) for invoking the liability referencing supplier discount matrix settlement methods 158, software services including an email service, and an electronic signature service, and technology platforms including a financial information reference service platform (i.e., Moneyline/Telerate), a trustee platform, and a supply chain finance business process & communication platform.

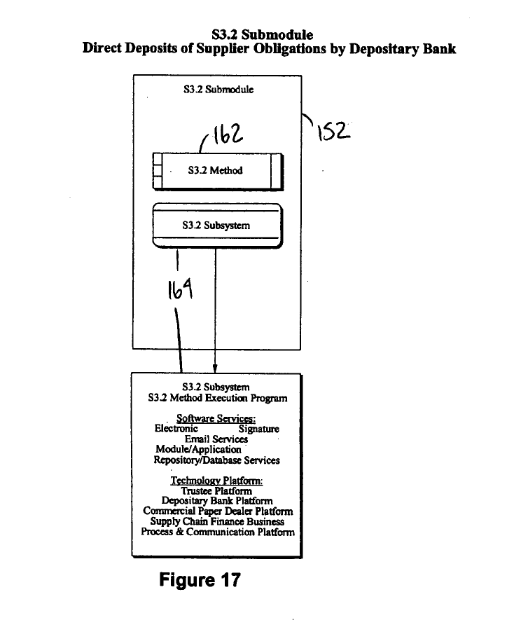

FIG. 17 shows in a block diagram an example of a depositary bank settlement submodule 152 for direct deposits, in accordance with an embodiment of the supply chain procurement, settlement and finance system 100. The direct deposits of obligations by the depositary bank settlement submodule 152 includes a memory for storing computer readable code representing depositary bank settlement methods 162 (or a set of instructions) for electronically performing the following tasks:
1. Trustee prepares a data file containing the Net Supplier Obligations and relevant bank deposit details (the “Direct Deposit File”). Preferably, Trustee uses a database file to create the Direct Deposit File. The form and layout of this Direct Deposit File is developed in consultation with the relevant bank.
2. On the Settlement Day, the Trustee receives confirmation that either the Net Cash under the Cash Deal Structure has been paid by the buyer 12 and has been deposited into the Buy-Sell Co.'s Bank, or that the Net Proceeds from the sale of the Promissory Note (sold at a Discount pursuant to the Promissory Note Sale Agreement) has been paid by the Commercial Paper Dealer 20 and has been deposited into the Buy-Sell Co.'s Bank account. Preferably, the Commercial Paper Dealer 20 uses electronic mail through the Internet to communicate the details used to determine Net Proceeds.
3. Trustee forwards the Direct Deposit File to the Buy-Sell Co.'s Bank with instructions to immediately transfer the Net Supplier Obligations from the Buy-Sell Co.'s bank account into the bank account of the relevant suppliers 14. Depositary Bank affects the transfer of funds from Buy-Sell Co.'s 18 accounts and deposits the Net Supplier Obligations into the accounts of the suppliers 14. The Trustee also forwards a copy of the Direct Deposit File to the Program Manager and to the buyer 12. Preferably, Trustee forwards the Direct Deposit File to the Bank over a VPN.
   The depositary bank settlement submodule 152 also includes depositary bank settlement architecture components 164 for providing communication between participants in the supply chain procurement, settlement and finance system 100. The depositary bank settlement architecture components 164 include a depositary bank settlement method invoker (or program) for invoking the depositary bank settlement methods 162, software services including an email service, an electronic signature service, a module/application service, and a repository/database service, and technology platforms including a depository bank platform, a trustee platform, a commercial paper dealer platform, and a supply chain finance business process & communication platform.

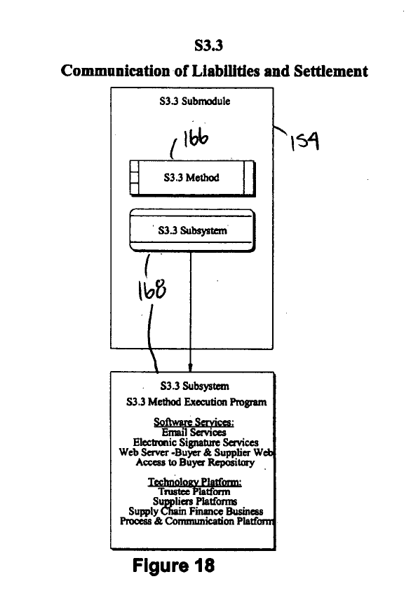

FIG. 18 shows in a block diagram an example of a communication of liabilities and settlement submodule 154, in accordance with an embodiment of the supply chain procurement, settlement and finance system 100. The communication of liabilities and settlement submodule 154 includes a memory for storing computer readable code representing communication of liabilities and settlement transaction methods 166 (or a set of instructions) for electronically performing the following tasks:
1. Program Manager updates the Business Process & Communication Platform by reference to the Schedule and the Direct Deposit File on a Supplier-by-Supplier basis. Preferably, the data contained in the Schedule and in the Direct Deposit File is imported and housed into the Business Process & Communication Platform and is available to suppliers 14 on demand at anytime using a web browser. Preferably, detailed data has the look and feel of an invoice and summary data has the look and feel of a remittance form. The Business Process & Communication Platform permits a viewer to export the data desired into a downloadable tab delineated text file. The user could import it into their database, accounting system or spreadsheet.
2. Trustee notifies all relevant suppliers 14 that the Buy-Sell Co. Business Process & Communication Platform contains relevant data and information for concerning recently completed Trades. Preferably, suppliers communicate by electronic mail through the Internet.
3. Using a permission based access system, suppliers 14 access their portion of the Business Process & Communication Platform and are able to retrieve relevant Supplier Settlement and Banking Details for completed Trades processed and settled by Buy-Sell Co. 18. The suppliers 14 are able to download such Supplier Settlement and Banking Details for processing into their management information and accounting systems. Preferably, suppliers 14 access the Business Process & Communication Platform using a browser through an Internet service provider.
   The communication of liabilities and settlement submodule 154 also includes communication of liabilities and settlement architecture components 168 for providing communication between participants in the supply chain procurement, settlement and finance system 100. The communication of liabilities and settlement architecture components 168 include a communication of liabilities and settlement method invoker (or program) for invoking the communication of liabilities and settlement methods 166, software services including an email service, an electronic signature service, a web server-buyer & supplier web access to buyer repository service, and technology platforms including a trustee platform, a supplier platform, and a supply chain finance business process & communication platform.

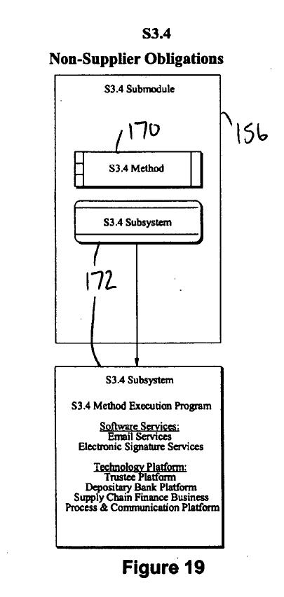

FIG. 19 shows in a block diagram an example of a non-supplier obligations settlement submodule 156, in accordance with an embodiment of the supply chain procurement, settlement and finance system 100. The non-supplier obligations settlement submodule 156 includes a memory for storing computer readable code representing non-supplier obligations settlement methods 170 (or a set of instructions) for electronically performing the following tasks:
1. Trustee settles Non-Supplier Obligations by making payment either through a web enabled payment system provided by the bank or by wire transfer. Preferably, Trustee prepares a bank transfer instruction in an agreed upon manner with the host bank. Such bank instruction can be forwarded either by email or by facsimile.
   The non-supplier obligations settlement submodule 156 also includes non-supplier obligations settlement architecture components 172 for providing communication between participants in the supply chain procurement, settlement and finance system 100. The non-supplier obligations settlement architecture components 172 include a non-supplier obligations settlement method invoker (or program) for invoking the non-supplier obligations settlement methods 170, software services including an email service, and an electronic signature service, and technology platforms including a depository bank platform, a trustee platform, and a supply chain finance business process & communication platform.

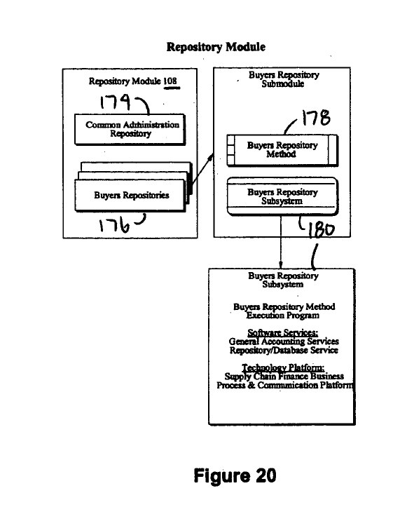

FIG. 20 shows in a block diagram an example of a repository module 108, in accordance with an embodiment of the supply chain procurement, settlement and finance system 100. The repository module 108 includes a common administration repository 174, and one or more buyer repositories 176. Each buyer repository 176 includes a memory for storing computer readable code representing invoice based transaction methods 178 (or a set of instructions) for electronically performing the following tasks:
1. Program Manager records all transactions represented by the Schedules, the Sale of a Promissory Note, the Direct Deposit Details and the payment of Non-Supplier Obligations into the books of Buy-Sell Co. 18. Preferably, Program Manager uses off-the-shelf accounting software to complete the recording process.
   The buyer repository 176 also includes buyer repository architecture components 180 for providing communication between participants in the supply chain procurement, settlement and finance system 100. The buyer repository architecture components 180 include a buyer repository method invoker (or program) for invoking the promissory note methods 178, software services including general accounting services and a repository/database service, and technology platforms including a supply chain finance business process & communication platform.

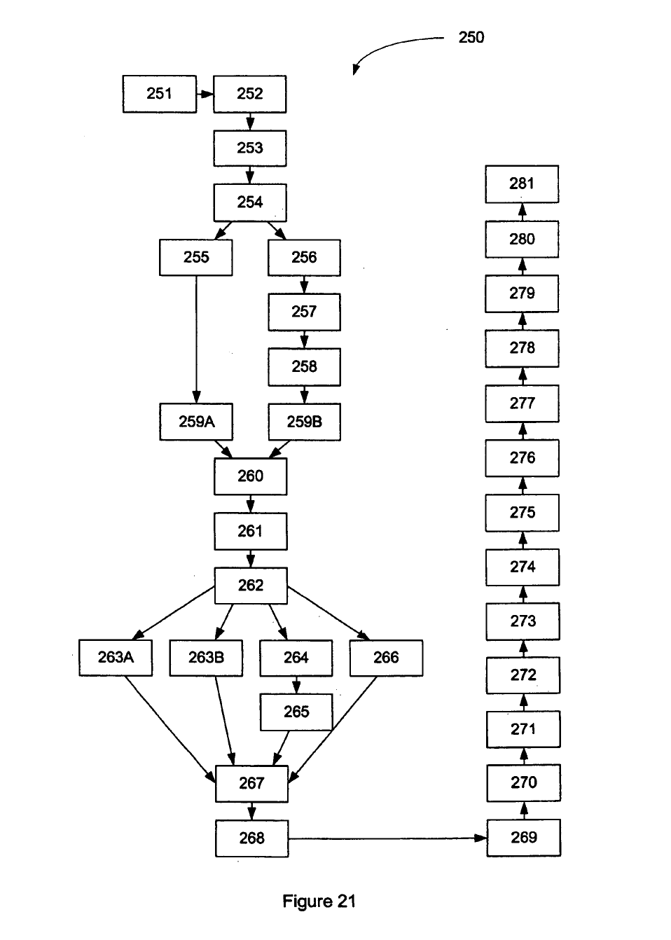

FIG. 21 shows in flowchart another example of a method of providing procurement and settlement logistics for buyers and financing for suppliers (250), in accordance with an embodiment of the supply chain procurement, settlement and finance system 100. The method (250) comprises the following process steps:

Process Steps on or before the Trade Date—
(251) As agent for Buy-Sell Co. 18, buyer 12 prepares and issues Purchase Orders to suppliers 14 in name of Buy-Sell Co. 18, and buyer 12 maintains all relevant Supplier Master Files. The buyer 12 negotiates, on behalf of Buy-Sell Co. 18, a Base Discount payable by suppliers 14 for early liquidity. The right to deduct a discount from the amount otherwise payable under a Purchase Order will be a right included with the Terms and Conditions in each Purchase Order issued to suppliers 14. The Discount Payable by suppliers 14 is indexed to the movement of Money-Rates over a Base Floor Rate. Each Purchase Order issued contains a Base Discount Rate Identifier that is employed to compute the amount of the discount payable by suppliers 14 in exchange for early payment of an obligation arising from completion of the Terms and Conditions contained in a Purchase Order issued by Buy-Sell Co. 18. Preferably, buyer 12 employs its existing purchase order process and management system to complete this process step (251).
(252) Buyer 12 agrees and warrants, under the Buy-Sell Agreement, to purchase from Buy-Sell Co. 18 the same goods and services as ordered from suppliers 14.
(253) Supplier 14 receives Purchase Orders and ships goods or provides services. In the case of goods, the suppliers 14 ship directly to buyer's facilities. Shipping and routing instructions are a component part of the Purchase Order issued by Buy-Sell Co. 18 to suppliers 14. Supplier 14 provides bar-code information on shipment or other suitable information (the “Shipping Data”). In addition to product descriptions, product codes and units shipped, the Shipping Data also includes relevant references to purchase order number, Supplier shipping references, date of shipment, etc. Preferably, suppliers 14 uses their existing fulfillment system to complete the Purchase orders received.
(254) As agent for Buy-Sell Co. 18, buyer 12 records Shipping Data and relevant receiving documentation (collectively, the “Performance Data”). Preferably, buyer 12 uses their existing receiving/management system.
(255) In the case of an Invoice Free System, buyer 12 prepares a Contract Liability Memo (“CLM”) for each receiving transaction by reference to the Performance Data and the underlying Purchase Order issued to suppliers 14. The CLM contains a Base Discount Rate Identifier supplied by Buy-Sell Co. 18 and published in its website for reference by suppliers 14. The Base Discount Rate Identifier is employed by the Buy-Sell Co. 18 to calculate the Discount payable by suppliers 14 in exchange for early payment.
(256) In the case of an Invoice Based System, supplier 14 prepares and delivers an Invoice to buyer 12 as agent for Buy-Sell Co. 18.
(257) Buyer 12 compares details contained in the Invoice received to receiving documents, to the Purchase Order issued and verifis the validity of the units billed and the accuracy of the amount included on the Invoice and the related value added taxes.
(258) In the case of an error or incorrect invoice, the buyer 12 returns the Invoice to the supplier 14 for correction.
(259) (a) Buyer 12 prepares a listing of all CLM processed in the case of an Invoice Free System or (the “Settlement Details”).
   (b) Buyer 12 prepares a listing of approved Invoices in the case of an Invoice Based System (the “Settlement Details”). The Settlement Details include appropriate folio references, including the Base Discount Rate Identifier. Preferably, buyer 12 uses its accounting system export function to create two flat files, both database importable, (summary and detailed data), or uses a recommended Settlement Appliance/accounts receivable subsystem.
(260) Buyer 12 electronically signs the Settlement Details and forwards same to the Custodian. Preferably, buyer 12 uses electronic signature technology that fulfills host country electronic signature laws. The buyer 12 forwards such Settlement Details to the Custodian using electronic mail through the Internet or the Settlement Appliance.
(261) Custodian time and date stamps the Settlement Details, appends a unique alpha numeric identity, signs the Settlement Details for identification purposes only, and holds in safekeeping the Settlement Details as a Schedule to the Buy-Sell Agreement. Preferably, Custodian uses a database to store such Settlement Details and also uses electronic signature technology to sign and identify the documents as the original electronic files.
(262) Custodian forwards a copy of the Schedule to the Trustee and the buyer 12 and the Program Manager. Preferably, Custodian forwards copies of Schedules by electronic mail through the Internet.
(263) (a) Under the Financing Structure, the Trustee, by reference to the copy of the Schedule, notifies the Commercial Paper Dealer 20 on the Trade Day that a Trade has been concluded and the amount of the ABCP to be issued and settled on the Settlement Day pursuant to the ABCP Agreement.
(b) Under the Non-Financing Structure, the Trustee advises the Commercial Paper Dealer 20 on the Trade Day that a Promissory Note has been received, the Face Value of such Promissory Note and that the sale of such Promissory Note will be made on the Settlement Day pursuant to the Promissory Note Sale Agreement. The means of notification and communication (whether by email or by facsimile) used by the Trustee to the Commercial Paper Dealer 20 is determined by the parties and will be then be an operating rule and procedure under either the ABCP Agreement or the Promissory Note Sale Agreement.

Process Steps on the Settlement Date—
(264) Under the Non-Financing Structure, the Trustee determines the Money-Rate in Effect on the Settlement Day, which Money-Rate is referenced in order to determine the Cash Discount payable when the buyer 12 settles its purchase obligations to Buy-Sell Co. 18 in Cash. On the Settlement Day, the buyer 12 pays the Net Cash as consideration for the Face Value of Supplier Obligations included in the Schedule. In one embodiment, the Business Structure assumes that the buyer 12 issues Commercial Paper to fund the payment of its obligations under the Cash Deal. The Cash Discount is intended to represent a re-imbursement of the finance costs and expenses incurred by the buyer 12.
(265) If the Terms of Settlement with the buyer 12 requires payment of Cash on Closing, the buyer 12 computes the Cash Obligation by deducting the Cash Discount from the Face Value of Supplier Obligations contained in the CLMs. The Non-Variable Components of the Cash Discount are defined in the Buy-Sell Agreement executed by the buyer 12 and Buy-Sell Co. 18. The Variable Component of the Cash Discount is the Money-Rate in Effect on the Settlement Day.
(266) If the Financing Structure is employed, the Trustee sells ABCP to Commercial Paper Dealers 20 to fund the early payment of Supplier Obligations purchased to be sold to customers or consumers of buyer 12. On the Trade Day, Trustee notifies the Commercial Paper Dealer 20 of the Face of the ABCP to be issued and sold pursuant to the ABCP Agreement. On the Settlement Day, the Commercial Paper Dealer 20 affects a transfer of the proceeds into the bank account maintained by Trustee on behalf of Buy-Sell Co. 18.
(267) Trustee, by reference to the Money-Rate in Effect, the Base Discount Rate Identifier and the relevant Discount Matrix, computes the Discount to be deducted from the Supplier Obligation and the Net Supplier Obligation owing for suppliers 12 included in the Schedule. Preferably, Trustee uses authorized external website for money rates and Buy-Sell Co.'s Business Process & Communication Platform for relevant discount matrix. Trustee uses Buy-Sell Co.'s unique Methods for computing Discounts.
(268) Trustee prepares a data file containing the Net Supplier Obligations and relevant bank deposit details (the “Direct Deposit File”). Preferably, Trustee uses a database file to create the Direct Deposit File. The form and layout of this Direct Deposit File is developed in consultation with the relevant bank.
(269) On the Settlement Day, the Trustee receives confirmation that either the Net Cash under the Cash Deal Structure has been paid by the buyer 12 and has been deposited into the Buy-Sell Co.'s Bank or that the Net Proceeds from the sale of the Promissory Note (sold at a Discount pursuant to the Promissory Note Sale Agreement) has been paid by the Commercial Paper Dealer 20 and has been deposited into the Buy-Sell Co.'s Bank account. Preferably, the Commercial Paper Dealer 20 uses electronic mail through the Internet to communicate the details used to determine Net Proceeds.
(270) Trustee forwards the Direct Deposit File to the Buy-Sell Co.'s Bank with instructions to immediately transfer the Net Supplier Obligations from the Buy-Sell Co.'s bank account into the bank account of the relevant suppliers 14. Depositary Bank affects the transfer of finds from Buy-Sell Co.'s accounts and deposits the Net Supplier Obligations into the accounts of the suppliers 14. The Trustee also forwards a copy of the Direct Deposit File to the Program Manager and to the buyer 12. Preferably, Trustee forwards the Direct Deposit File to the Bank over a VPN.
(271) Program Manager updates the Business Process & Communication Platform by reference to the Schedule and the Direct Deposit File on a Supplier-by-Supplier basis. Preferably, the data contained in the Schedule and in the Direct Deposit File is imported and housed into the Business Process & Communication Platform, and is available to suppliers 14 on demand at anytime using a web browser. Preferably, detailed data have the look and feel of an invoice, and summary data have the look and feel of a remittance form. The Business Process & Communication Platform will permit a viewer to export the data desired into a downloadable tab delineated text file. The user could import it into their database, accounting system or spreadsheet.
(272) Trustee notifies all relevant suppliers 14 that the Buy-Sell Co. Business Process & Communication Platform contains relevant data and information for concerning recently completed Trades. Preferably, suppliers 14 communicate by electronic mail through the Internet.
(273) Using permission based access system, suppliers 14 access their portion of the Business Process & Communication Platform and are able to retrieve relevant Supplier Settlement and Banking Details for completed Trades processed and settled by Buy-Sell Co. 18. The suppliers are able to download such Supplier Settlement and Banking Details for processing into their management information and accounting systems. Preferably, suppliers 14 access the Business Process & Communication Platform using a browser through an Internet service provider.
(274) Trustee settles Non-Supplier Obligations by making payment either through a web enabled payment system provided by the bank or by wire transfer. Preferably, Trustee prepares a bank transfer instruction in an agreed upon manner with the host bank. Such bank instruction is preferably forwarded either by email or by facsimile.
(275) Program Manager records all transactions represented by the Schedules, the Sale of a Promissory Note, the Direct Deposit Details and the payment of Non-Supplier Obligations into the books of Buy-Sell Co. 18. Preferably, Program Manager uses off-the-shelf accounting software to complete the recording process.

Process Steps on Collection and ABCP Repayment Days—
(276) As Goods and Services are sold, the buyer 12 prepares a report (the “Daily Sales Report”), which identifies the Goods and Services that have been sold since the Settlement Day. The Sponsor electronically signs and then forwards the Daily Sales to the Custodian using the VPN. The Daily Sales Report contains relevant Bank Deposit information. The proceeds from the sale of Goods and Services are deposited into a Special Trust Account maintained by the Trustee. This Special Trust Account is used solely for the redemption of the ABCP previously by the SPE under the Financing Structure.
(277) On receipt of the Daily Sales Report, the Custodian [a] date stamps and identifies the file as the “Original Daily Sales Report”; [b] signs the file electronically for identification purposes only; and [c] places the file in safekeeping as an addendum to the Buy-Sell Agreement. Custodian forwards copies of the Original Daily Sales Report over the VPN to the buyer 12, the Program Manager and the Trustee.
(278) Program Manager updates the accounting records of the SPE to reflect the Sale or the collection of Goods and Services and the deposit of Sale Proceeds into the Special Trust Account.
(279) Program Manager, on a daily basis, provides the buyer 12 and the Trustee with Financial Statements of the SPE, including details of Assets and Unsold or Uncollected Goods and Services by Performance Period.
(280) On each Maturity Date, the Trustee retires the ABCP by payment from the Special Trust Account.
(281) Program Manager updates the Accounting Records of the SPE to reflect the repayment of the ABCP.

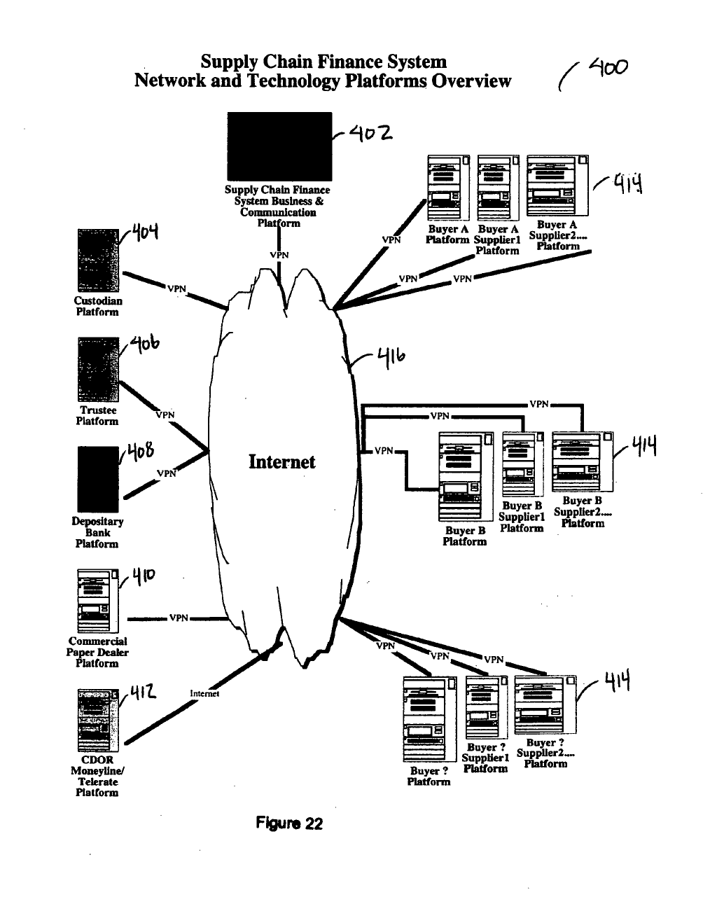

FIG. 22 shows in a component diagram an example of a network and technology platform 400, in accordance with an embodiment of the supply chain procurement, settlement and finance system 100. The platform 400 comprises a supply chain finance system business & communication platform 402, a custodian platform 404, a trustee platform 406, a depository bank platform 408, a commercial paper dealer platform 410, a financial information reference service (i.e., Moneyline/Telerate) platform 412, and one or more buyer platforms 414. With the exception of the financial information reference service platform 412, the platforms communicate through a VPN through the Internet 416. As illustrated by Buyers A, B and “?”, multiple buyers and their suppliers may be connected by secure Virtual Private Networking through the Internet to the Supply Chain Finance System Business Process and Communications Platform 400.

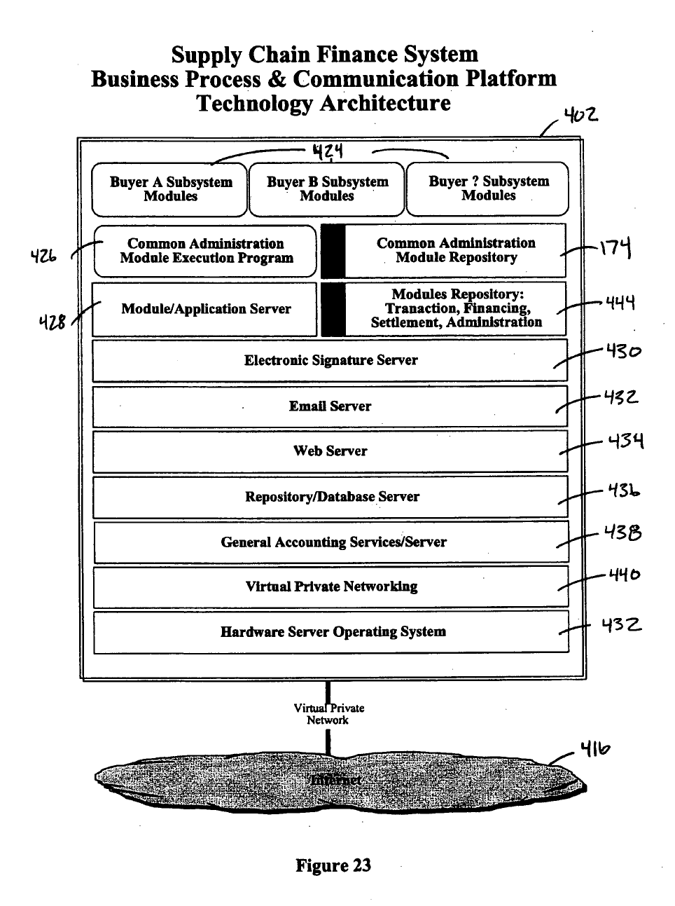

FIG. 23 shows an example of a business process and communication platform (BPCP) technology architecture 402, in accordance with an embodiment of the supply chain procurement, settlement and finance system 100. The BPCP technology architecture 402 comprises one or more buyer subsystem modules 424, a common administration module execution program 426, a module/application server 428, an electronic signature server 430, an email server 432, a web server 434, a repository/database server 436, a general accounting services server 436, a virtual private networking module 440, a hardware server operating system 442, a common administration module repository 174, and a modules repository 444 for computer programs that support execution of modules and submodules. The BPCP architecture communicates to other platforms through a VPN to the Internet 416.

The business process and communications platform (BPCP) 402 comprises data processing, storage and networking hardware, operating system software, software servers, an Internet connection, and custom coded computer programs formed into subsystems that deliver submodule or modularized business functions. Ultimately, supply chain financial services are furnished.

In one implementation, the data processing hardware is based on blade technology that offers parallel processing and easy expansion when more capacity is needed. The supply chain financing system architecture segments software services into separate but coordinated servers where practical. The server types include: general accounting, repository/database, web, email, electronic signature and module/application. All of these servers are housed in one blade device. If the supply chain procurement, settlement and finance system 100 is broadly adopted, it is conceivable that thousands of buyers and hundreds of thousands of suppliers will use the BPCP. Performance can be improved by strategically distributing software servers and or subsystems on separate blade devices. This is possible because of the software services segmentation and the use of servers.

The foundation of the BPCP 402 is defined as the data processing, storage and networking hardware, the blade operating system, the software servers, and the VPN/Internet connection. Upon this foundation, a library of generalized supply chain procurement, settlement and finance system 100 modules, (Transaction 102, Financing 104, Settlement 106, Administration) and submodules are installed into the Modules Repository 444.

Buyer subsystems 424 may be added, changed or deleted using administration functions in the Common Administration Module Execution Program 426. Once transaction and financing structures are chosen, Transaction, Financing, Settlement and Repository modules from the Modules Repository 444 are installed into a System Modules Execution Program that then becomes a buyer subsystem 424. In one embodiment, the buyer subsystem 424 is a computer program loop that executes through Transaction, Financing, and Settlement modules each time an authenticated Buyer Client Liability Memo email is received. The module/application server 428 executes the modules. Many of the process steps or methods performed by the Custodian, Trustee and Depositary Bank are automated. For ongoing buyer 12 and supplier 14 enquiries and communications, a web portal interface to the buyer subsystem repository is provided and supported by the web server 434.

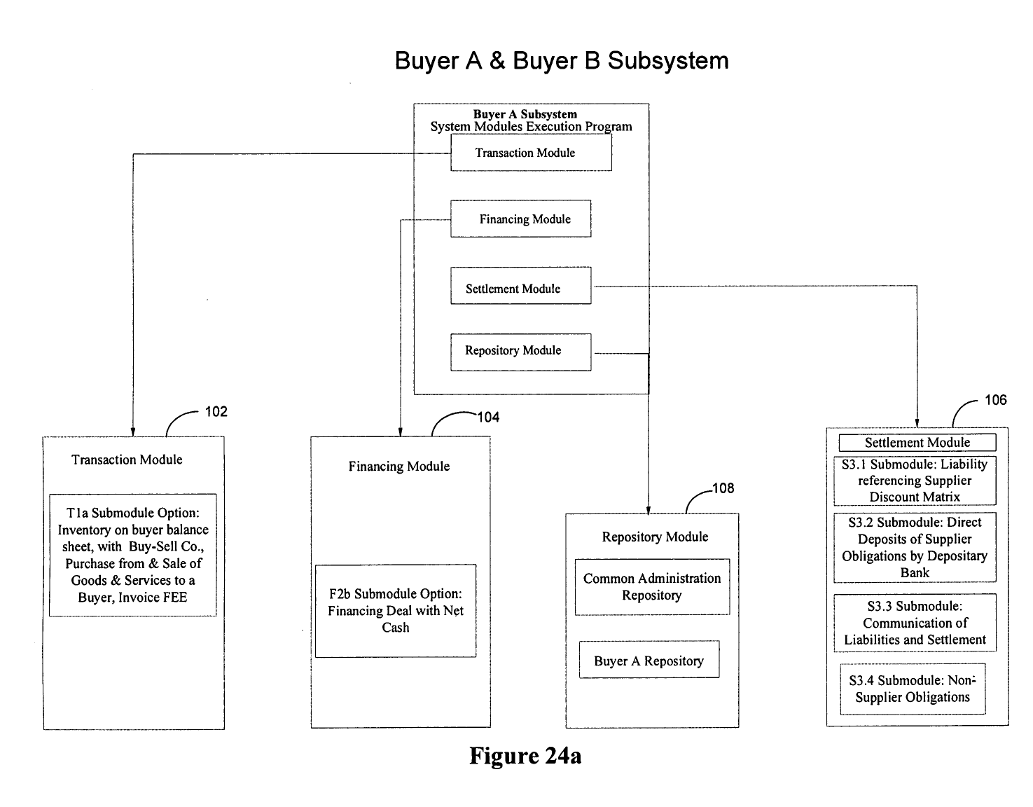

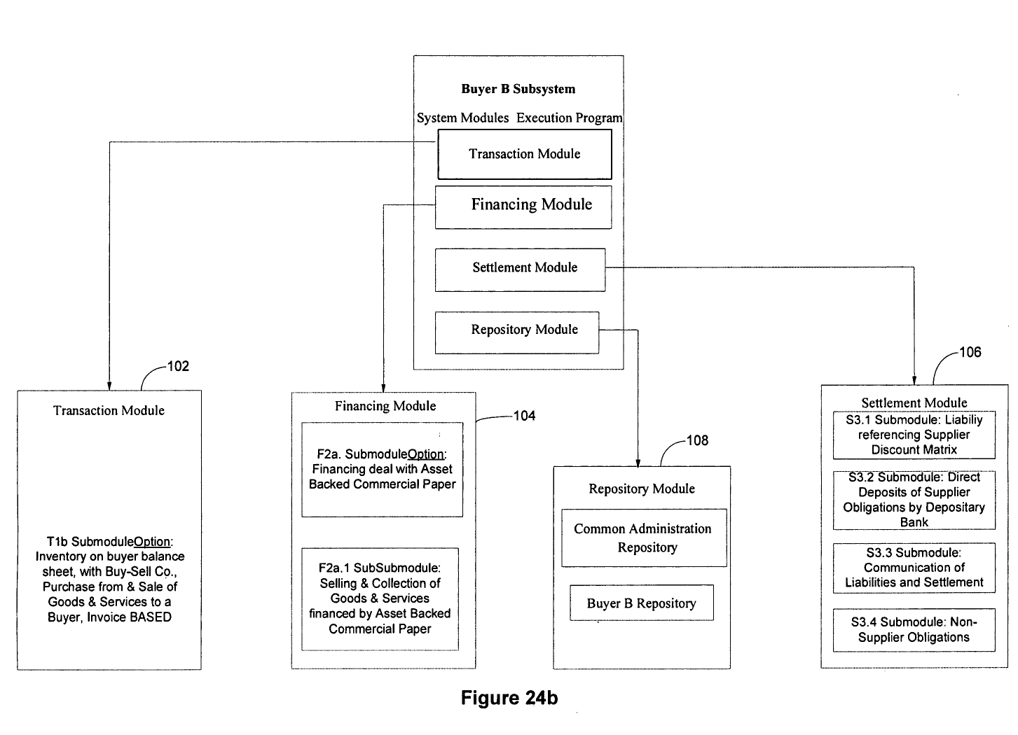

FIG. 24 shows two examples of buyer subsystems 424, in accordance with an embodiment of the supply chain procurement, settlement and finance system 100. The buyer subsystems 424 show examples of the selection of submodules used in two different uses of the supply chain procurement, settlement and finance system 100. Buyer A subsystem 424 shows an example of an invoice free, cash payment based use, while Buyer B subsystem 424 shows an example of an invoice based, asset backed commercial paper financed user.

Advantages to the Participants

Advantageously, the supply chain procurement, settlement and finance system 100 can revolutionize how supply chains are managed and financed. Advantageously, buyers can see a significant increase in shareholder values (approximately equal to 1.5%-2.0% of the financial volumes facilitated by the system 100 multiplied by the price earnings ratio of such buyer). Suppliers will see a significant reduction in finance, process, management and administrative costs, along with an increase in stockholder values. The goal of the system 100 is to provide continuing liquidity to suppliers within 1-3 days following completion of a trade (the “Settlement Day”).

For Buyers 12

The following is a summary of certain operating benefits of the supply chain procurement, settlement and finance system 100 for buyers 12:
Buyers no longer need to operate or manage an accounts payable system;
Buyers will improve their reporting transparencies by always being in a position to measure and report on issued and outstanding purchase commitments;
Buyer will improve its ability to forecast and manage its cash flow and meet future liabilities with much greater certainty;
The control exerted over the assets of the Buyer is greatly improved since the supply chain procurement, settlement and finance system 100 requires that all purchases by made pursuant to Purchase Orders; and
Buyers will greatly improve their working relationships with Suppliers.
   The following is a summary of certain of the financial benefits of the supply chain procurement, settlement and finance system for buyers 12:
Buyers can avoid the cost of processing invoices from Suppliers;
Buyers can greatly reduce dispute resolution costs with Suppliers;
Buyers can avoid the cost of settling Supplier Obligations;
Buyers can reduce management and administrative costs associated with accounts payable and cash flow management;
Buyers can share in the Buy-Sell Profits (see Definitions above); and
Buyers can improve shareholder values.
   For Suppliers 14

Prior to adoption of the supply chain procurement, settlement and finance system 100, suppliers 14, by extending credit, were effectively operating as bankers to buyers 12. Adoption of the supply chain procurement, settlement and financing system 100 changes the nature of the relationship between buyers 12 and suppliers 14.

The following is a summary of certain operating benefits of the supply chain procurement, settlement and finance system 100 for suppliers 14:
Suppliers can avoid having to operate or manage an accounts receivable system;
Suppliers can know within 1-3 days the status of a shipment to a Buyer;
Suppliers can improve their ability to forecast and manage their cash flow and meet future liabilities with much greater certainty; and
Suppliers can improve their working relationships with Buyers.
   The following is a summary of certain of the financial benefits of the supply chain procurement, settlement and finance system 100 for suppliers 14:
Suppliers can avoid the cost of processing invoices to Buyers;
Suppliers can reduce dispute resolution costs with Buyers;
Suppliers can reduce management and administrative costs associated with accounts receivable and cash flow management;
Suppliers can reduce their cost of financing and managing the trading relationship with Buyers (estimated to range from 20% to 50% depending upon the capital structure of each Supplier and the collection term of its receivables);
By not requiring financing facilities to support their trading relationships, Suppliers can improve their ability to secure other sources of financing and funding;
By no longer having to support accounts receivable balances on their books, Suppliers can effectively be recapitalized as a result of the system 100 (For example, if a Supplier employed $25 of capital to support a $100 receivable from a Buyer, the $25 would be released and be available for the Supplier to use for other business purposes);
The system 100 represents either the only source of liquidity or a new and less expensive source of financing for Suppliers; and
Suppliers can prove shareholder values.
   For Commercial Paper Dealers

Prior to adoption of the supply chain procurement, settlement and finance system 100, Commercial Paper facilitated very little B2B financing for suppliers 14. Under the system 100, Commercial Paper can be the dominant instrument used to finance all B2B relationships. In most cases, such Commercial Paper is purchased by Commercial Paper Dealers and resold to the Capital Markets. Commercial Paper Dealers can earn significant fees from such activities.

For the Capital Markets

The Capital Markets (pension plans, money-market funds, etc.) are able to purchase high quality Commercial Paper in volumes not previously available.

For B2B Marketplaces

If the system 100 is broadly adopted by Supply Chains within a certain marketplace, the results for such a marketplace can be profound. By releasing the capital previously employed by suppliers 14 to support trading relationships and by greatly reducing the cost of process, management and administration, the marketplace will become more flexible, dynamic and competitive.

For Customers and Consumers

The efficiencies and reduction in costs for buyers 12 and suppliers 14 under the system 100 will eventually result in reduced costs and prices for Customers and Consumers of Buyers.

The systems and methods according to the present invention may be implemented by any hardware, software or a combination of hardware and software having the functions described above. The software code, either in its entirety or a part thereof, may be stored in a computer readable memory. Further, a computer data signal representing the software code that may be embedded in a carrier wave may be transmitted via a communication network. Such a computer readable memory and a computer data signal are also within the scope of the present invention, as well as the hardware, software and the combination thereof.

While particular embodiments of the present invention have been shown and described, changes and modifications may be made to such embodiments without departing from the true scope of the invention.

What is claimed is:

1. A supply chain procurement, settlement and finance system for providing supply chain procurement, settlement and finance, the system comprising:
a transaction module for purchasing and receiving goods and services from a supplier;
a finance module for providing a financial interest for the goods and services;
a settlement module for determining and settling supplier and non-supplier obligations; and
a repository for storing buyer data and administration data of the transaction module, finance module and settlement module.

2. The system as claimed in claim 1, wherein the transaction module includes one or more of:
a process submodule for computing the liability owing to suppliers when invoices are not required to determine or process liabilities;
a process submodule for computing the liability owing to suppliers when invoices are required to process liabilities; and
a process submodule for receiving settlement details from a custodian delivered and prepared by the buyer under a buy-sell agreement.

3. The system as claimed in claim 1, wherein the finance module includes means for performing one or more of the following functions:
generating and selling asset backed commercial paper to fund the purchase of goods and services;
collecting cash from a buyer;
collecting a promissory note from a buyer;
selling the promissory note to a financial market;
collecting the proceeds from the sale of goods and services to customers and consumers of the buyer; and
repaying the previously issued asset backed commercial paper.

4. The system as claimed in claim 1, wherein the finance module includes one or more of:
a cash receipt submodule for receiving funds from a capital market entity in exchange for the asset backed commercial paper;
a cash receipt submodule for receiving funds from a buyer as compensation for the sale of goods and services purchased by a buy-sell company from suppliers;
a cash receipt submodule for receiving finds from a capital market entity as consideration from the sale of promissory notes;
means for determining the discount allowed a buyer in exchange for cash payment on closing of a sale of goods and services to the buyer;
means for determining the discount allowed a purchaser of promissory notes received originally in exchange for the sale of goods and services to a buyer;
a cash receipt submodule for receiving proceeds from the sale of goods and services sold to customers and consumers of buyer; and
a cash disbursement submodule for retiring the asset backed commercial paper.

5. The system as claimed in claim 1, wherein the settlement module includes one or more of:
a process submodule for determining the discount payable by suppliers and net supplier obligations;
a process submodule for preparing a direct deposit file, which will include the net supplier obligations and related supplier banking information and for making payments to suppliers;
a submodule for communication settlement details and settlement amounts to suppliers; and
a process submodule for determining the amounts payable to non-suppliers.

6. The system as claimed in claim 1, further comprising:
a business process and communication platform for hosting the functionality of the supply chain procurement, settlement and finance system;
a supplier platform for allowing a supplier to communicate with the supply chain procurement, settlement and finance system via a network connection;
a buyer platform for allowing a buyer to communicate with the supply chain procurement, settlement and finance system via a network connection;
a financial market platform for allowing a financial market entity to communicate with the supply chain procurement, settlement and finance system via a network connection;
a custodian platform for allowing a custodian to communicate with the supply chain procurement, settlement and finance system via a network connection;
a trustee platform for allowing a trustee to communicate with the supply chain settlement, procurement and finance system via a network connection; and
a depositary bank platform for allowing a depositary bank to communicate with the supply chain settlement, procurement and finance system via a network connection.

7. A method of supply chain procurement, settlement and finance, the method comprising the steps of:
issuing to a supplier a purchase order for goods and services;
providing a financial interest to the goods and services;
computing the amount owing to a supplier when an invoice is not used as the primary document to determine a liability to a supplier;
processing invoices and tabulating liabilities owing to suppliers;
paying the supplier;
selling and collecting proceeds from the sale of goods and services sold to customers and consumers of buyer; and
retiring the financial interest to the goods and services.

8. The method as claimed in claim 7, wherein the step of issuing includes the step of sending an electronic purchase order to a supplier.

9. The method as claimed in claim 7, wherein the step of providing a financial interest includes the steps of:
issuing asset backed commercial paper for the goods and services;
selling the asset backed commercial paper to financial markets; and
obtaining a performance covenant from a buyer.

10. The method as claimed in claim 7, wherein the step of paying includes the step of receiving proceeds from one or more of:
a cash sale of goods and services to a buyer;
a sale of the promissory notes received from a buyer to financial markets; and
selling asset backed commercial paper to financial markets.

11. The method as claimed in claim 7, wherein the step of retiring includes the steps of:
receiving proceeds from the sale of goods and services; and
applying the proceeds to repay the previously issued asset backed commercial paper.

12. The method as claimed in claim 7, further comprising the steps of:
determining a Base Discount Rate to be applied to supplier obligations; and
determining the Base Discount payable by suppliers for early payment, when the Money-Rate is at certain stated Base Money-Rate and where the right to take such Base Discount is a term and condition of a purchase order issued to such supplier.

13. The method as claimed in claim 7, further comprising the steps of:
determining a Discount Rate to be applied to supplier obligations; and
determining a Discount payable by suppliers for early payment, when the Money-Rate in effect exceeds the Base Money-Rate included in a Base Discount Rate and where the right to take such Discount is a term and condition of a purchase order issued to such supplier.

14. The method as claimed in claim 7, further comprising the steps of:
determining a Discount Rate Matrix included by reference in a purchase order;
employing the purchase order to determine the Discount Rate applied on a Settlement Day by reference to a Money-Rate in effect on such Settlement Day.

15. The method as claimed in claim 7, further comprising the step of determining a Cash Discount applied to reduce an obligation payable by a buyer in exchange for early payment for goods and services purchased under a Buy-Sell Agreement, such Cash Discount including a Non-Variable and a Variable Component, the Variable Component equal to the Term Money-Rate in effect on the Settlement Day.

16. A computer data signal embodied in a carrier wave and representing sequences of instructions which, when executed by a processor, cause the processor to perform a method of supply chain procurement, settlement and finance, the method comprising the steps of:
issuing to a supplier a purchase order for goods and services;
receiving settlement details from a buyer and a custodian;
providing a financial interest to the goods and services;
determining a liability owing to suppliers of goods and services;
paying the supplier;
communicating settlement and banking details to suppliers; and
retiring the financial interest to the goods and services.

17. A carrier wave embodying a computer data signal representing sequences of instructions which, when executed by a processor, cause the processor to perform a method of supply chain procurement, settlement and finance, the method comprising the steps of:
issuing to a supplier a purchase order for goods and services;
receiving settlement details from a buyer and a custodian;
providing a financial interest to the goods and services;
determining the liability owing to suppliers of goods and services;
paying the supplier;
communicating settlement and banking details to suppliers; and
retiring the financial interest to the goods and services.

18. A computer program product for use in the execution in a computer of a supply chain procurement, settlement and finance system for providing supply chain procurement, settlement and finance, the computer program product comprising:
a transaction module for purchasing and receiving goods and services from a supplier;
a finance module for providing a financial interest for the goods and services;
a settlement module for determining and settling supplier and non-supplier obligations; and
a repository for storing buyer data and administration data of the transaction module, finance module and settlement module.
